(19) United States
(12) Patent Application Publication
(10) Pub. No.: US 2012/0247291 A1
(43) Pub. Date: Oct. 4, 2012

(54) BONDED GLASS CUTTING METHOD, PACKAGE MANUFACTURING METHOD, PACKAGE, PIEZOELECTRIC VIBRATOR, OSCILLATOR, ELECTRONIC APPARATUS, AND RADIO-CONTROLLED TIME PIECE

(76) Inventor: Yasuo Kawada, Chiba-shi (JP)

(21) Appl. No.: 13/432,446

(22) Filed: Mar. 28, 2012

(30) Foreign Application Priority Data
Mar. 29, 2011 (JP) 2011-071735

(51) Int. Cl. B26D 3/00

(52) U.S. Cl. 83/33

(57) ABSTRACT

Disclosed is a bonded glass cutting method including: a first focus adjustment process of focusing laser light; a second focus adjustment process of moving the focus of the laser light toward one surface side of the bonded glass along a thickness direction of the bonded glass, after the first focus adjustment process; a detection target portion forming process of forming a detection target portion on one surface by irradiation of the laser light, after the second focus adjustment process; a third focus adjustment process of refocusing the laser light on the detection target portion; a groove forming process of forming a groove on one surface by irradiation of the laser light along the planned cutting line, after the third focus adjustment process.

### RELATED APPLICATIONS

This application claims priority under 35 U.S.C. §119 to Japanese Patent Application No. 2011-071735 filed on Mar. 29, 2011, the entire content of which is hereby incorporated by reference.

### BACKGROUND OF THE INVENTION

In recent years, in a mobile phone or a portable information terminal device, a piezoelectric vibrator (package) which employs quartz or the like has been used as a time source, a timing source of a control signal or the like, a reference signal source, or the like. As this type of piezoelectric vibrator, a variety of piezoelectric vibrators has been proposed, in which a piezoelectric vibrator of a surface mount device (SMD) type is known as an example thereof. For example, this type of piezoelectric vibrator includes a base substrate and a lid substrate which are bonded to each other, a cavity which is formed between both the substrates, and a piezoelectric vibrating piece (electronic component) which is accommodated in the cavity in an air-tightly sealed state.

In this regard, in manufacturing the piezoelectric vibrator as described above, recess portions for cavities are formed on a wafer for lid substrates and piezoelectric vibrating pieces are mounted on a wafer for base substrates, and then, both the wafers are anodically bonded to each other through an adhesive layer, to thereby form a wafer bonded body in which a plurality of packages is formed in a matrix direction of the wafers. Then, the wafer bonded body is cut for each package (each cavity) formed in the wafer bonded body, to thereby manufacture a plurality of piezoelectric vibrators (packages) in which the piezoelectric vibrating piece is air-tightly sealed in the cavity.

In this regard, as a cutting method of the wafer bonded body, a method of cutting (dicing) a wafer bonded body along a thickness direction thereof, using a blade in which a diamond is attached to its tooth tip, has been proposed, for example.

However, in the cutting method using the blade, it is necessary to form a cutting margin between the cavities in consideration of the width of the blade, and thus, such problems arise that the number of piezoelectric vibrators extracted from one sheet of wafer bonded body becomes small, chippings are generated in cutting, and its cut surface becomes coarse. Further, the processing speed is lowered, thereby decreasing the production efficiency.

Further, a method of forming a scratch (scribe line) along a planned cutting line on the surface of a wafer bonded body using a diamond which is embedded in the tip end of a metallic bar and applying a tear stress along the scribe line for cutting has been proposed.

However, in this method, lots of chippings are generated on the scribe line, and thus, the wafers are easily broken and the surface precision of its cut surface becomes poor.

In this regard, in order to solve the above problems, a method of cutting a wafer bonded body using laser has been developed. In this method, for example, as disclosed in Japanese Patent No. 3408805, a focus point is formed inside the wafer bonded body and is irradiated by laser light, to thereby form a modified region along a planned cutting line of the wafer bonded body by a large amount of photon absorption. Then, a tear stress (impact force) is applied to the wafer bonded body, to thereby cut the wafer bonded body using the modified region as a starting point.

### SUMMARY OF THE INVENTION

In this regard, as the method of cutting the wafer bonded body using laser as described above, a method may be considered in which the surface of the wafer bonded body is irradiated by laser light along a planned cutting line thereof to form a scribe line and a tear stress is then applied along the scribe line for cutting.

Here, since the thickness of a wafer for base substrates, the thickness of a wafer for lid substrates and the thickness of an adhesive film are uneven for each wafer bonded body, the entire thickness of the wafer bonded body is different for each wafer bonded body. Thus, when the scribe line is formed on the surface of the wafer bonded body, if the focal position of the laser light is fixedly set, the depth, width and the like of the scribe line become uneven for each wafer bonded body due to the different thicknesses of the wafer bonded bodies. In this case, the quality of the piezoelectric vibrator may be affected.

Thus, it is necessary to perform a process of forming a focus of the laser light on the surface of the wafer bonded body for each wafer bonded body, which lengthens the processing time. Further, when focusing is performed as described, small frictional traces or foreign substances on the surface of the wafer bonded body are used as an indicator in order to form the focus in this way, which may take time in addition.

Further, a method may be considered in which the thicknesses of the wafer bonded bodies are measured in advance one by one and the focal position of laser light is adjusted on the basis of the measurement result. However, in this case, it is laborious to measure the thicknesses of the wafer bonded bodies, which lowers the manufacturing efficiency.

An advantage of some aspects of the invention is to provide a bonded glass cutting method, a package manufacturing method, a package, a piezoelectric vibrator, an oscillator, an electronic apparatus, and a radio-controlled time piece in which a groove can be formed on a surface of a bonded glass with high accuracy and high efficiency.

According to a first aspect of the invention, there is provided a bonded glass cutting method for cutting, along a planned cutting line, a bonded glass in which bonding surfaces of a plurality of glass substrates are bonded to each other through a bonding material, the method including: a first focus adjustment process of focusing laser light which is able to irradiate the bonded glass from the side of one surface thereof on the bonding material by imaging the bonding material from the one surface side of the bonded glass; a second focus adjustment process of moving the focus of the laser light toward the one surface side of the bonded glass along a thickness direction of the bonded glass by an estimated thickness of the irradiated glass substrate, after the first focus adjustment process; a detection target portion forming process of forming a detection target portion on the one surface by irradiation of the laser light, after the second focus adjustment process; a third focus adjustment process of refocusing the laser light on the detection target portion by imaging the detection target portion from the one surface side; a groove forming process of forming a groove on the one surface along the planned cutting line by irradiation of the laser light along the planned cutting line, after the third focus adjustment process; and a cutting process of cutting the bonded glass along the planned cutting line by applying a tear stress along the planned cutting line.

Here, the irradiated glass substrate refers to a glass substrate which forms the one surface of the bonded glass among the plurality of glass substrates.

According to this configuration, by focusing the laser light on the bonding material with accuracy in the first focus adjustment process, and then, by forming the detection target portion on the one surface of the bonded glass through the second focus adjustment process, it is possible to reliably form the detection target portion on the one surface without action on the thickness of the glass substrates, the thickness of the bonding material and the like which are not irradiated by the laser light. Thus, in the groove forming process, as the groove is formed using the laser light focused on the detection target portion in the third focus adjustment process, it is possible to form the groove on the one surface with high accuracy.

In this way, it is possible to efficiently form the groove without performing the process of measuring the thicknesses of the bonded glasses one by one.

Further, in the first focus adjustment process, since the first focus adjustment process is performed by imaging the bonding material which bonds the glass substrates, it is not necessary to add a new component to the bonded glass. Thus, it is possible to suppress the structure of the bonded glass from being complicated, and to efficiently cut the bonded glass.

Further, it is possible to accurately and smoothly refocus the laser light on the detection target portion by imaging the detection target portion formed in the detection target portion forming process. Thus, the above-described effects become remarkable, compared with a case where the imaging is performed using frictional traces or foreign substances as an indicator.

Further, it is possible to continuously perform the first focus adjustment process to the groove forming process as a series of flows, and thus, it is not necessary to form in advance a structure such as a detection target portion in the bonded glass, and it is possible to more efficiently cut the bonded glass.

Further, in the detection target portion forming process, the detection target portion may be formed in a shape of a straight line which is parallel to the planned cutting line.

According to this configuration, since the detection target portion is formed in the straight line shape in the detection target portion forming process, it is possible to refocus the laser light at a plurality of locations along an extension direction of the detection target portion in the third focus adjustment process, and to form the groove on the one surface with high accuracy.

Further, at this time, since the detection target portion is formed in the straight line shape which is parallel to the planned cutting line, it is possible to simplify a device configuration of an emitting section which emits the laser light.

According to a second aspect of the invention, there is provided a manufacturing method of a package which is provided with a cavity in which an electric component is able to be sealed inside the bonded glass, using the bonded glass cutting method as described above, wherein the bonded glass is cut along the planned cutting lines which partition regions where the plurality of packages is formed, in the cutting process.

According to this configuration, since the package is manufactured using the bonded glass cutting method according to the first aspect, it is possible to form the groove on the one surface of the bonded glass with high accuracy and high efficiency. Thus, it is possible to increase the number of packages with high quality extracted from one sheet of bonded glass, thereby enhancing the yield ratio.

Further, in the detection target portion forming process, the detection target portion may be formed in a portion of the one surface excluding the regions where the packages are formed.

According to this configuration, since the detection target portion is formed in the portion of the one surface of the bonded glass excluding the regions where the packages are formed in the detection target portion forming process, it is possible to reliably enhance the yield ratio.

Further, according to a third aspect of the invention, there is provided a package formed using the package manufacturing method as described above, wherein a chamfer portion obtained by tearing the groove is provided in an outer edge portion of a surface which is configured by the one surface of the bonded glass.

According to this configuration, since the chamfer portion is formed, even though a tool for extracting the package is in contact with a corner portion of the package when the cut package is extracted, it is possible to suppress generation of chippings due to the contact, to thereby prevent the package from being broken due to the chippings. Thus, it is possible to secure air-tightness in the cavity, to thereby provide a package with high reliability.

Here, since the chamfer portion can be automatically formed by cutting the bonded glass along the groove (planned cutting line) after the groove is formed by the laser, it is not necessary to form each chamfer portion in the package after being cut in a different process. As a result, it is possible to suppress cost increases and to enhance the process efficiency, compared with a case where the chamfer portion is formed in a different process.

Further, according to a fourth aspect of the invention, there is provided a piezoelectric vibrator in which a piezoelectric vibrating piece is air-tightly sealed in the cavity of the package as described above.

According to this configuration, it is possible to provide a piezoelectric vibrator with superior vibration characteristics and high reliability, in which air-tightness in the cavity is secured.

Further, according to a fifth aspect of the invention, there is provided an oscillator in which the piezoelectric vibrator as described above is electrically connected to an integrated circuit as an oscillator element.

Further, according to a sixth aspect of the invention, there is provided an electronic apparatus in which the piezoelectric vibrator as described above is electrically connected to a timer section.

Further, according to a seventh aspect of the invention, there is provided a radio-controlled time piece in which the piezoelectric vibrator as described above is electrically connected to a filter section.

Since the oscillator, the electronic apparatus and the radio-controlled time piece according to these aspects have the piezoelectric vibrator as described above, it is possible to provide a product with high reliability, in a similar way to the piezoelectric vibrator.

According to the bonded glass cutting method of the invention, it is possible to form the groove on the one surface of the bonded glass with high accuracy and high efficiency.

Further, according to the package manufacturing method of the invention, since the package is formed using the above-described bonded glass cutting method according to the invention, it is possible to increase the number of packages with high quality which are extracted from one sheet of bonded glass, thereby enhancing the yield ratio.

Further, according to the package of the invention, since the package is formed using the above-described bonded glass cutting method according to the invention, it is possible to secure air-tightness in the cavity, and to provide a package with high reliability.

Further, according to the piezoelectric vibrator of the invention, it is possible to provide a piezoelectric vibrator with superior vibration characteristics and high reliability, in which air-tightness in the cavity is secured.

According to the oscillator, the electronic apparatus and the radio-controlled time piece of the invention, since the piezoelectric vibrator as described above is provided, it is possible to provide a product with high reliability, in a similar way to the piezoelectric vibrator.

### BRIEF DESCRIPTION OF THE DRAWINGS

FIG. 1 is an appearance perspective view of a piezoelectric vibrator according to an embodiment of the invention, when seen from a lid substrate side.

FIG. 2 is an appearance perspective view of a piezoelectric vibrator according to an embodiment of the invention, when seen from a base substrate side.

FIG. 3 is a diagram illustrating an internal configuration of a piezoelectric vibrator, which is a plan view of a piezoelectric vibrating piece in a state where a lid substrate is removed.

FIG. 4 is a cross-sectional view of a piezoelectric vibrator taken along line A-A shown in FIG. 3.

FIG. 5 is an exploded perspective view of a piezoelectric vibrator shown in FIG. 1.

FIG. 6 is a flowchart illustrating the manufacturing flow of a piezoelectric vibrator shown in FIG. 1.

FIG. 7 is a diagram illustrating a process of manufacturing a piezoelectric vibrator according to the flowchart shown in FIG. 6, which is an exploded perspective view illustrating a wafer bonded body in which a wafer for base substrates and a wafer for lid substrates are anodically bonded to each other in a state where piezoelectric vibrating pieces are accommodated in cavities.

FIG. 8 is a flowchart illustrating the flow of a dividing process.

FIG. 9 is a diagram illustrating a dividing process, which is a cross-sectional view illustrating a state where a wafer bonded body is held in a magazine.

FIG. 10 is a diagram illustrating a dividing process, which is a cross-sectional view illustrating a state where a wafer bonded body is held in a magazine.

FIG. 11 is a diagram illustrating a dividing process, which is a plan view illustrating a state where a wafer bonded body is held in a magazine.

FIG. 12 is a diagram illustrating a dividing process, which is a cross-sectional view illustrating a state where a wafer bonded body is held in a magazine.

FIG. 13 is a diagram illustrating a dividing process, which is a cross-sectional view illustrating a state where a wafer bonded body is held in a magazine.

FIG. 14 is a diagram illustrating a dividing process, which is a cross-sectional view illustrating a state where a wafer bonded body is held in a magazine.

FIG. 15 is a diagram illustrating a dividing process, which is a cross-sectional view illustrating a state where a wafer bonded body is held in a magazine.

FIG. 16 is a diagram illustrating a dividing process, which is a cross-sectional view illustrating a state where a wafer bonded body is held in a magazine.

FIG. 17 is a diagram illustrating a trimming process, which is a plan view of a wafer for base substrates illustrating a state where a wafer for lid substrates of a wafer bonded body is removed.

FIG. 18 is a diagram illustrating a protection film forming process, which is a cross-sectional view illustrating a state where a plurality of piezoelectric vibrators is attached to a UV tape.

FIG. 19 is a diagram illustrating a marking process, which is an appearance perspective view of a piezoelectric vibrator corresponding to FIG. 1.

FIG. 20 is a configuration diagram illustrating an oscillator according to an embodiment of the invention.

FIG. 21 is a configuration diagram illustrating an electronic apparatus according to an embodiment of the invention.

FIG. 22 is a configuration diagram illustrating a radio-controlled time piece according to an embodiment of the invention.

### DETAILED DESCRIPTION OF THE PREFERRED EMBODIMENTS

Hereinafter, embodiments of the invention will be described with reference to the accompanying drawings.

### (Piezoelectric Vibrator)

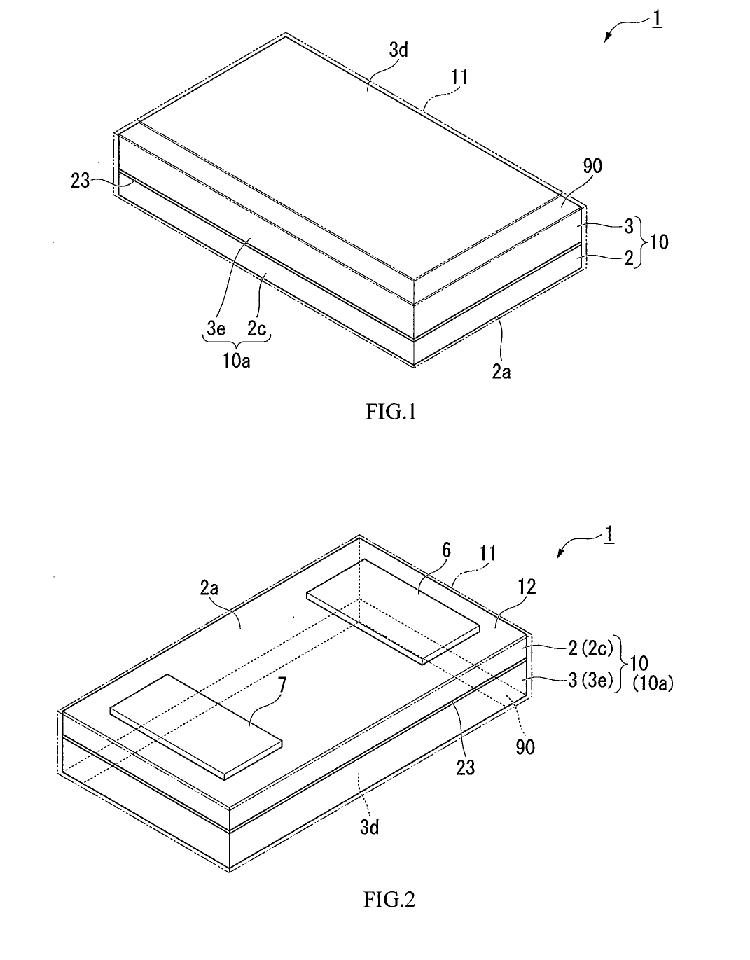

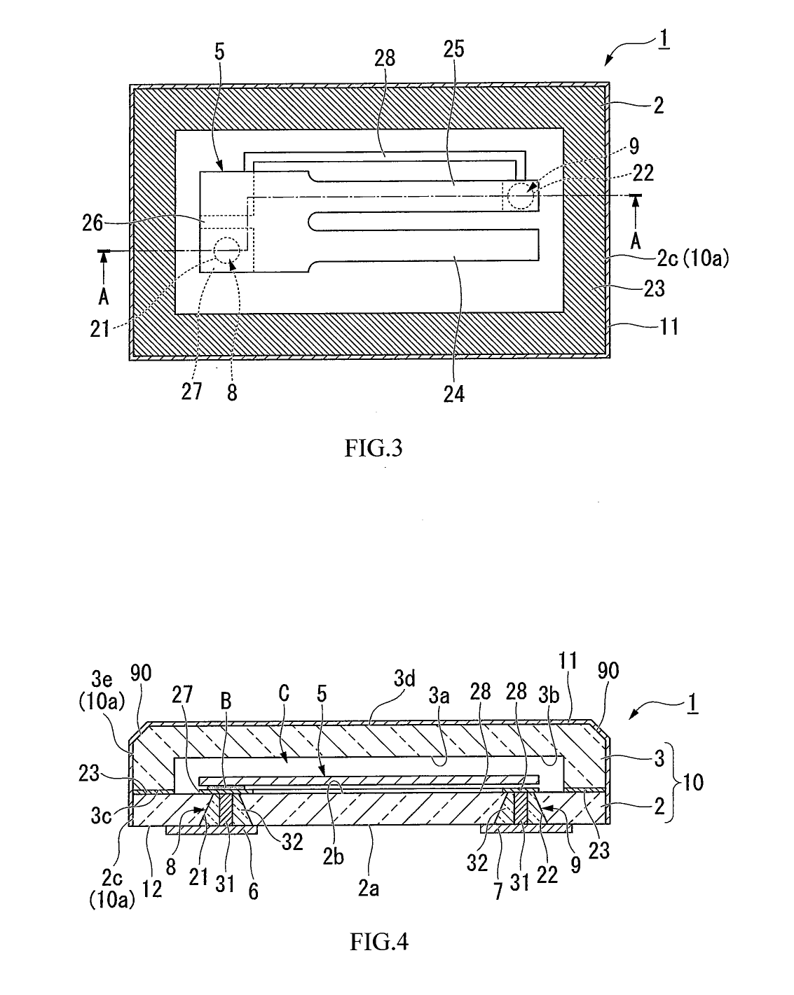

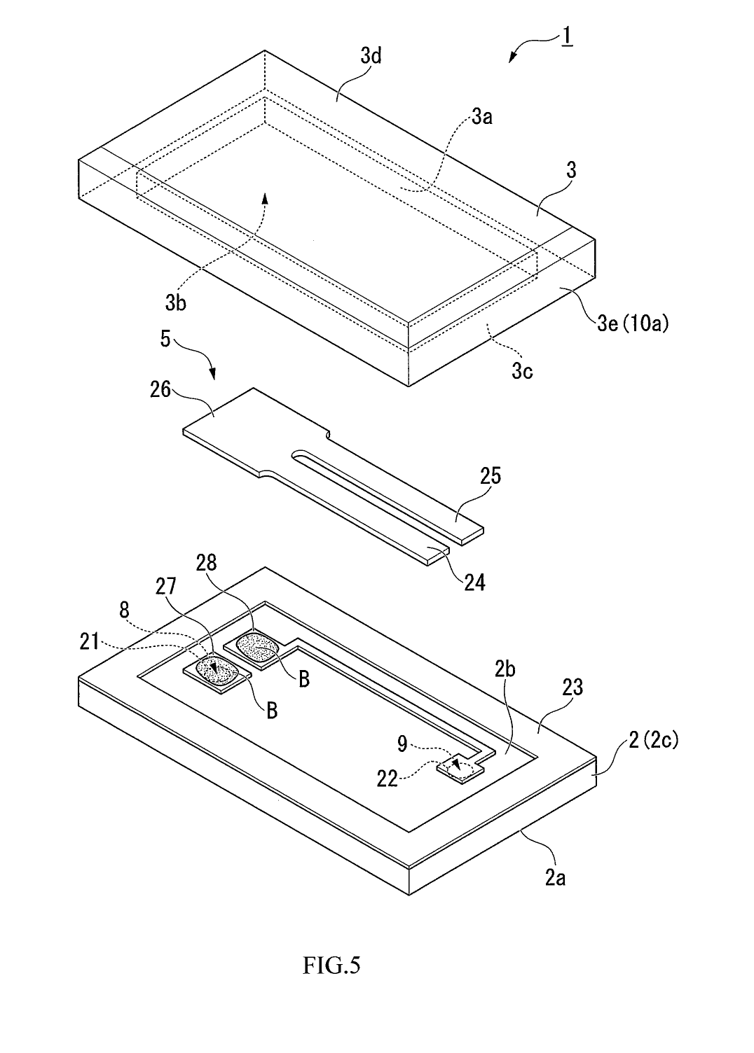

FIG. 1 is an appearance perspective view of a piezoelectric vibrator according to an embodiment of the invention, when seen from a lid substrate side, and FIG. 2 is an appearance perspective view thereof, when seen from a base substrate side. Further, FIG. 3 is a diagram illustrating an internal configuration of a piezoelectric vibrator, which is a diagram illustrating a piezoelectric vibrating piece in a state where a lid substrate is removed, when seen from an upper side. Further, FIG. 4 is a cross-sectional view of a piezoelectric vibrator taken along line A-A shown in FIG. 3, and FIG. 5 is an exploded perspective view of a piezoelectric vibrator. In FIG. 4, a protection film (which will be described later) is represented as a chain line, and in FIG. 5, the protection film is omitted.

As shown in FIGS. 1 to 5, a piezoelectric vibrator 1 according to the present embodiment is a piezoelectric vibrator 1 of a surface mount type, which includes a box shaped package 10 in which a base substrate (first substrate) 2 and a lid substrate (second substrate) 3 are anodically bonded through a bonding material 23, and a piezoelectric vibrating piece (electronic component) 5 which is accommodated in a cavity C of the package 10. Further, the piezoelectric vibrating piece 5, and external electrodes 6 and 7 which are disposed on a rear surface 2a (lower surface in FIG. 4) of the base substrate 2 are electrically connected to each other through a pair of through hole electrodes 8 and 9 which pass through the base substrate 2.

The base substrate 2 is formed in a plate shape by a transparent insulation substrate made of a glass material, for example, soda-lime glass. A pair of through holes 21 and 22, in which the pair of through hole electrodes 8 and 9 is formed, is formed on the base substrate 2. The through holes 21 and 22 form tapered cross-sectional shapes in which their diameter is gradually decreased toward a front surface 2b (upper surface in FIG. 4) from the rear surface 2a of the base substrate 2.

The lid substrate 3 is a transparent insulation substrate made of a glass material, for example, soda-lime glass, in a similar way to the base substrate 2, and is formed in a plate shape to have the size capable of overlapping with the base substrate 2. Further, on a rear surface 3b (lower surface in FIG. 4) of the lid substrate 3, a recess portion 3a of a rectangular shape in which the piezoelectric vibrating piece 5 is accommodated is formed. When the base substrate 2 and the lid substrate 3 overlap with each other, the recess portion 3a forms the cavity C which accommodates the piezoelectric vibrating piece 5. Further, the lid substrate 3 is anodically bonded with the base substrate 2 through the bonding material (bonding film) 23 in a state where the recess portion 3a faces the side of the base substrate 2. That is, the recess portion 3a which is formed in the center and a frame region 3c which is formed around the recess portion 3a and forms a bonding surface with respect to the base substrate 2 are formed on the side of the rear surface 3b of the lid substrate 3.

Further, a chamfer portion 90 in which a corner portion of the lid substrate 3 is chamfered is formed on an upper edge of the lid substrate 3, in a scribing process (which will be described later) in a manufacturing process of the piezoelectric vibrator 1.

The piezoelectric vibrating piece 5 is a vibrating piece of a tuning fork type which is formed of a piezoelectric material such as quartz crystal, lithium tantalite, or lithium noibate, which vibrates as a predetermined voltage is supplied thereto.

The piezoelectric vibrating piece 5 is a vibrating piece of a tuning fork type which includes one pair of vibrating arms 24 and 25 which are arranged in parallel and a base portion 26 which integrally fixes the base ends of the pair of vibrating arms 24 and 25. The piezoelectric vibrating piece 5 includes an excitation electrode which includes one pair of a first excitation electrode and a second excitation electrode (not shown) which vibrate the vibrating arms 24 and 25 on outer surfaces of the pair of vibrating arms 24 and 25, and one pair of mount electrodes which electrically connect the first excitation electrode and the second excitation electrode with guide electrodes 27 and 28 (which will be described later) (all not shown).

As shown in FIGS. 3 and 4, the piezoelectric vibrating piece 5 as configured above is bump-bonded on the guide electrode 27 and 28 which are formed on the front surface 2b of the base substrate 2 using a bump B such as gold. More specifically, the first excitation electrode of the piezoelectric vibrating piece 5 is bump-bonded on one guide electrode 27 through one mount electrode and the bump B, and the second excitation electrode is bump-bonded on the other guide electrode 28 through the other mount electrode and the bump B. Thus, the piezoelectric vibrating piece 5 is supported in a state of being floated from the front surface 2b of the base substrate 2, and the respective mount electrodes and the guide electrodes 27 and 28 are electrically connected with each other.

Further, a bonding material 23 for anodic bonding, which is made of Al, is formed on the side of the front surface 2b of the base substrate 2 (on the side of the bonding surface on which the lid substrate 3 is bonded). This bonding material 23 has a film thickness of approximately 3000 Å to 5000 Å, for example, and is formed along an outer peripheral portion of the base substrate 2 to face the frame region 3c of the lid substrate 3. Further, as the bonding material 23 and the frame region 3c of the lid substrate 3 are anodically bonded with each other, the cavity C is sealed in a vacuum. The side surface of the bonding material 23 is formed on an approximately the same surface as the side surfaces 2c and 3e of the base substrate 2 and the lid substrate 3 (side surface (outer side surface) 10a of the package 10).

The external electrodes 6 and 7 are installed on opposite sides of the rear surface 2a of the base substrate 2 (surface which is opposite to the bonding surface in the substrate 2) in the length direction, and are electrically connected to the piezoelectric vibrating piece 5 through the respective through hole electrodes 8 and 9 and the respective guide electrodes 27 and 28. More specifically, one external electrode 6 is electrically connected to one mount electrode of the piezoelectric vibrating piece 5 through one through hole electrode 8 and one guide electrode 27. Further, the other external electrode 7 is electrically connected to the other mount electrode of the piezoelectric vibrating piece 5 through the other through hole electrode 9 and the other guide electrode 28. The side surfaces (outer circumferential edge) of the external electrodes 6 and 7 are positioned on an inner side with reference to the side surface 2c of the base substrate 2.

The through hole electrodes 8 and 9 are formed by a cylindrical body 32 and a core portion 31 which are integrally fixed to the through holes 21 and 22 by burning, and function to maintain air-tightness in the cavity C by completely closing the through holes 21 and 22 and to electrically conduct the external electrodes 6 and 7 and the guide electrodes 27 and 28. Specifically, one through hole electrode 8 is positioned below the guide electrode 27 between the external electrode 6 and the base portion 26, and the other through hole electrode 9 is positioned below the guide electrode 28 between the external electrode 7 and the excitation arm 25.

The cylindrical body 32 is obtained by burning a glass frit in the form of paste. The cylindrical body 32 is formed in a cylinder shape which has flat opposite ends and has approximately the same thickness as that of the base substrate 2. Further, the core portion 31 is arranged to pass through a central hole of the cylindrical body 32, in the center of the cylindrical body 32. Further, in the present embodiment, according to the shapes of the through holes 21 and 22, the appearance of the cylindrical body 32 is formed to be a conical shape (tapered cross-sectional shape). Further, the cylindrical body 32 is burned in a state of being embedded in the through holes 21 and 22, and is tightly fixed to the through holes 21 and 22.

The above-described core portion 31 is a conductive core member which is formed in a cylindrical shape by a metallic material, and is formed to have flat opposite ends and approximately the same thickness as the thickness of the base substrate 2, in a similar way to the cylindrical body 32. In the through hole electrodes 8 and 9, the electric conductivity is secured through the conductive core portions 31.

Here, as shown in FIGS. 1 to 5, a protection film 11 is formed on the package 10 so as to cover an entire region which includes a front surface 3d of the lid substrate 3, the side surface 3e of the lid substrate 3 and the side surface 2c of the base substrate 2 (side surface 10a of the package 10). The protection film 11 is formed of a metallic material such as silicon (Si), chrome (Cr) or Titanium (Ti) which is higher in corrosion resistance than the bonding material 23 (ionization tendency is small). Here, Si or Cr among these metallic materials is preferably used in the present embodiment. Thus, it is possible to enhance adhesiveness between the protection film 11, and the base substrate 2 and the lid substrate 3, thereby suppressing generation of a gap between the protection film 11 and the substrates 2 and 3, or suppressing separation of the protection film 11 from the substrates 2 and 3.

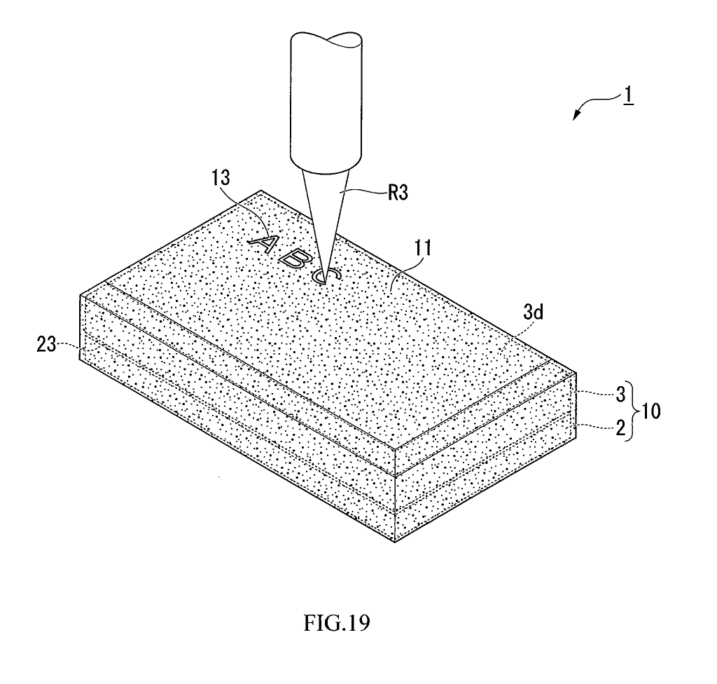

The protection film 11 has a film thickness of about 1000 Å, for example, on the front surface 3d of the lid substrate 3 (surface which is opposite to the bonding surface in the lid substrate 3). Further, an engraved marking 13 of the product type, product number, date of packing and the like is formed on the front surface 3d of the lid substrate 3 by removing a part of the protection film 11 using a laser light R3 (see FIG. 19). In order to form the marking 13, it is preferable to form the protection film 11 by Si which has a high absorption factor of the laser light R3.

Further, the protection film 11 has a film thickness of about 300 to 400 Å, for example, on the side surface 10a of the package 10, and is formed to cover the bonding material 23 which is exposed to the outside from between the base substrate 2 and the lid substrate 3. Further, the circumferential end (lower end in FIG. 4) of the protection film 11 is formed on approximately the same surface as the rear surface 2a of the base substrate 2. That is, the protection film 11 is not formed on the rear surface 2a of the base substrate 2. In this case, as described above, since the side surfaces of the external electrodes 6 and 7 are positioned on the inner side with reference to the side surface 2c of the base substrate 2, the circumferential end of the protection film 11 and the external electrodes 6 and 7 are separated from each other with a gap 12 being interposed therebetween. Thus, even in a case where a conductive material is used as the material of the protection film 11, since the external electrodes 6 and 7 are not bridged by the protection film 11, it is possible to prevent a short circuit of the external electrodes 6 and 7.

In a case where the piezoelectric vibrator 1 having such a configuration is operated, a predetermined drive voltage is applied to the external electrodes 6 and 7 which are formed on the base substrate 2. Thus, it is possible to allow electric current to flow in each excitation electrode of the piezoelectric vibrating piece 5, and to vibrate the pair of vibrating arms 24 and 25 at a predetermined frequency in a direction where they move close to or away from each other. Further, it is possible to use the piezoelectric vibrator 1 as a time source, a timing source of a control signal, a reference signal source, or the like, using the vibration of the pair of vibrating arms 24 and 25.

### (Manufacturing Method of Piezoelectric Vibrator)

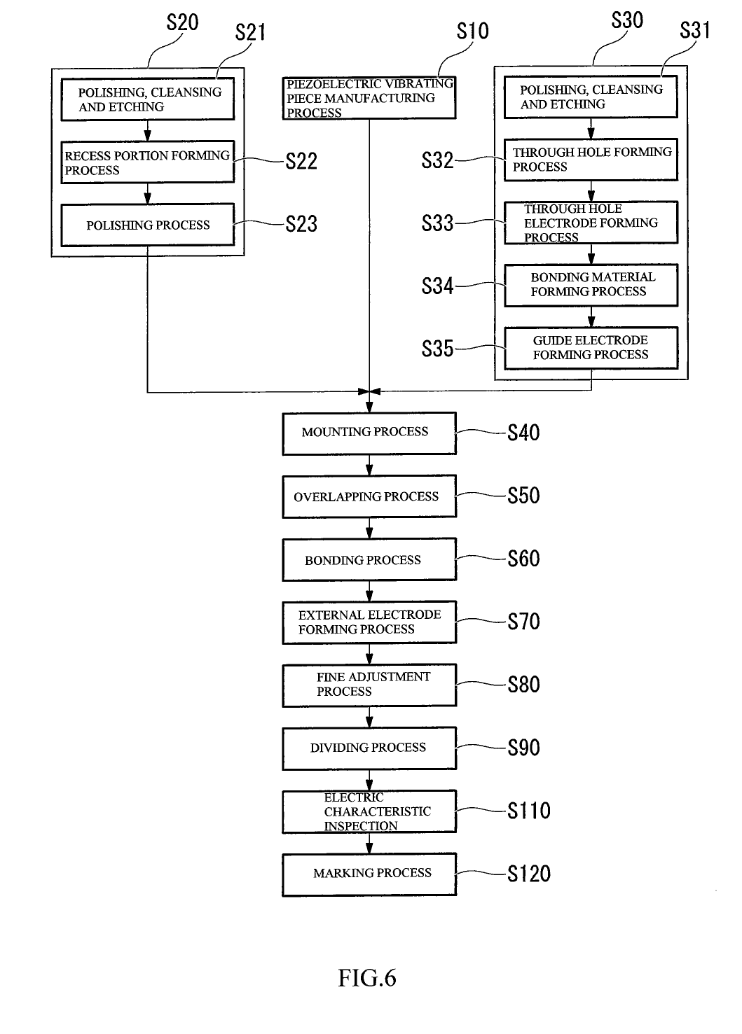

Next, a manufacturing method of the piezoelectric vibrator as described above will be described with reference to a flowchart shown in FIG. 6.

Firstly, as shown in FIG. 6, the piezoelectric vibrating piece 5 shown in FIGS. 1 to 5 is manufactured by performing a piezoelectric vibrating piece manufacturing process (S10). Further, after the piezoelectric vibrating piece 5 is manufactured, a coarse adjustment of resonance frequency is performed. A fine adjustment of adjusting the resonance frequency with higher accuracy is performed after mounting.

### (First Wafer Manufacturing Process)

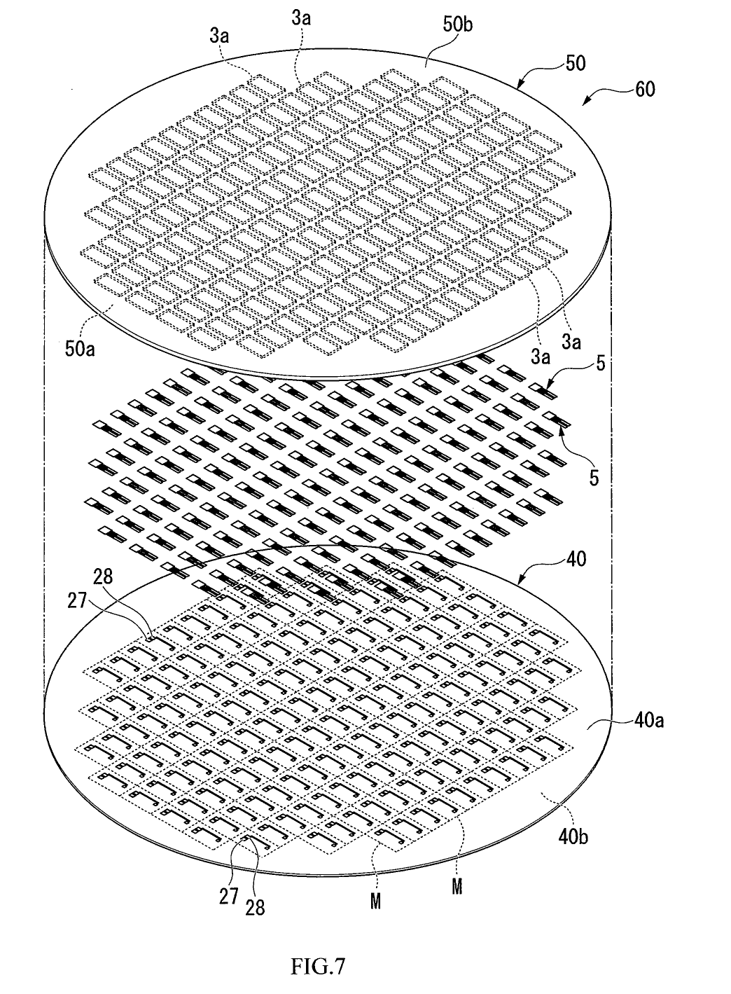

FIG. 7 is an exploded perspective view of a wafer bonded body in which a wafer for base substrates and a wafer for lid substrates are anodically bonded in a state where a piezoelectric vibrating piece is accommodated in a cavity.

Next, as shown in FIG. 7, a first wafer manufacturing process is performed for manufacturing a wafer 50 for lid substrates which becomes the lid substrate 3 later up to a state immediately before the anodic bonding is performed (S20). Specifically, a soda-lime glass is polished to have a predetermined thickness and is cleansed, and then, a disk-shaped wafer 50 for lid substrates is formed by removing a modified layer of the outermost surface by etching or the like (S21). Then, a recess portion forming process is performed for forming a plurality of recess portions 3a for the cavities C in a matrix direction by etching or the like on a rear surface 50a (lower surface in FIG. 7) of the wafer 50 for lid substrates (S22).

Next, in order to secure air-tightness with respect to the wafer 40 for base substrates (which will be described later), a polishing process (S23) is performed for polishing at least the side of the rear surface 50a of the wafer 50 for lid substrates which becomes the bonding surface with the wafer 40 for base substrates for specular working of the rear surface 50a. Through the above-described processes, the first wafer manufacturing process (S20) ends.

### (Second Wafer Manufacturing Process)

Next, at the same time as in the above-described process or at a timing before and after the above-described process, a second wafer manufacturing process is performed for manufacturing the wafer 40 for base substrates which becomes the base substrate 2 later up to a state immediately before the anodic bonding is performed (S30). Firstly, a soda-lime glass is polished to have a predetermined thickness and is cleansed, and then, the wafer 40 for base substrates of a disc shape is formed by removing a modified layer of the outermost surface by etching or the like (S31). Then, a through hole forming process is performed for forming a plurality of through holes 21 and 22 for arrangement of one pair of through hole electrodes 8 and 9 in the wafer 40 for base substrates by press working or the like, for example (S32). Specifically, by forming recess portions from the rear surface 40b (the other surface of the bonded glass) of the wafer 40 for base substrates by press working or the like, and by performing polishing from at least the side of the front surface 40a of the wafer 40 for base substrates to open the recess portions, it is possible to form the through holes 21 and 22.

Subsequently, a through hole electrode forming process (S33) is performed for forming the through hole electrodes 8 and 9 in the through holes 21 and 22 which are formed in the through hole forming process (S32). Thus, in the through holes 21 and 22, the core portions 31 are held at the same level as the front and rear surfaces 40a and 40b (upper and lower surfaces in FIG. 7) of the wafer 40 for base substrates. Through the above-described processes, it is possible to form the through hole electrodes 8 and 9.

Next, a bonding material forming process is performed for patterning a conductive material on the front surface 40a of the wafer 40 for base substrates to form the bonding material 23 (S34), and a guide electrode forming process is performed (S35). The bonding material 23 is formed in a region other than the region where the cavities C in the wafer 40 for base substrates are formed, that is, in the entire bonding region with respect to the rear surface 50a of the wafer 50 for lid substrates. Through the above-described processes, the second wafer manufacturing process (S30) ends.

Next, each piezoelectric vibrating piece 5 which is manufactured in the piezoelectric vibrating piece manufacturing process (S10) is mounted on the respective guide electrodes 27 and 28 of the wafer 40 for base substrates which is manufactured in the second wafer manufacturing process (S30), through the bump B such as gold (S40). Further, an overlapping process is performed for overlapping the wafer 40 for base substrates and the wafer 50 for lid substrates which are manufactured in the above-described manufacturing processes of the respective wafers 40 and 50 (S50). Specifically, using a reference mark or the like (not shown) as an indicator, the wafers 40 and 50 are aligned in correct positions. Thus, the mounted piezoelectric vibrating piece 5 becomes in the state of being accommodated in the cavity C which is surrounded by the recess portion 3a which are formed on the wafer 50 for lid substrates and the wafer 40 for base substrates.

After the overlapping process, two overlapped wafers 40 and 50 are disposed in an anodic bonding device (not shown), and a bonding process is performed for performing anodic bonding by applying a predetermined voltage in a predetermined temperature atmosphere in a state where an outer peripheral portion of the wafers is clamped by a holding mechanism (not shown) (S60). Specifically, the predetermined voltage is applied between the bonding material 23 and the wafer 50 for lid substrates. Then, an electrochemical reaction occurs in an interface between the bonding material 23 and the wafer 50 for lid substrates, so that they are tightly attached and anodically bonded to each other. Thus, it is possible to seal the piezoelectric vibrating piece 5 in the cavity C, thereby obtaining a wafer bonded body 60 (for example, thickness of about 0.4 mm to 0.9 mm) in which the wafer 40 for base substrates and the wafer 50 for lid substrates are bonded to each other. Further, by anodically bonding the wafers 40 and 50 as in the present embodiment, it is possible to prevent deviation due to deterioration with time, shock or the like, warping of the wafer bonded body 60, or the like, thereby tightly bonding the wafers 40 and 50, compared with a case where the wafers 40 and 50 are bonded to each other by an adhesive or the like.

Thereafter, one pair of external electrodes 6 and 7 which is electrically connected to one pair of through hole electrodes 8 and 9, respectively, is formed (S70), and the fine adjustment of the frequency of the piezoelectric vibrator 1 is performed (S80).

### (Dividing Process)

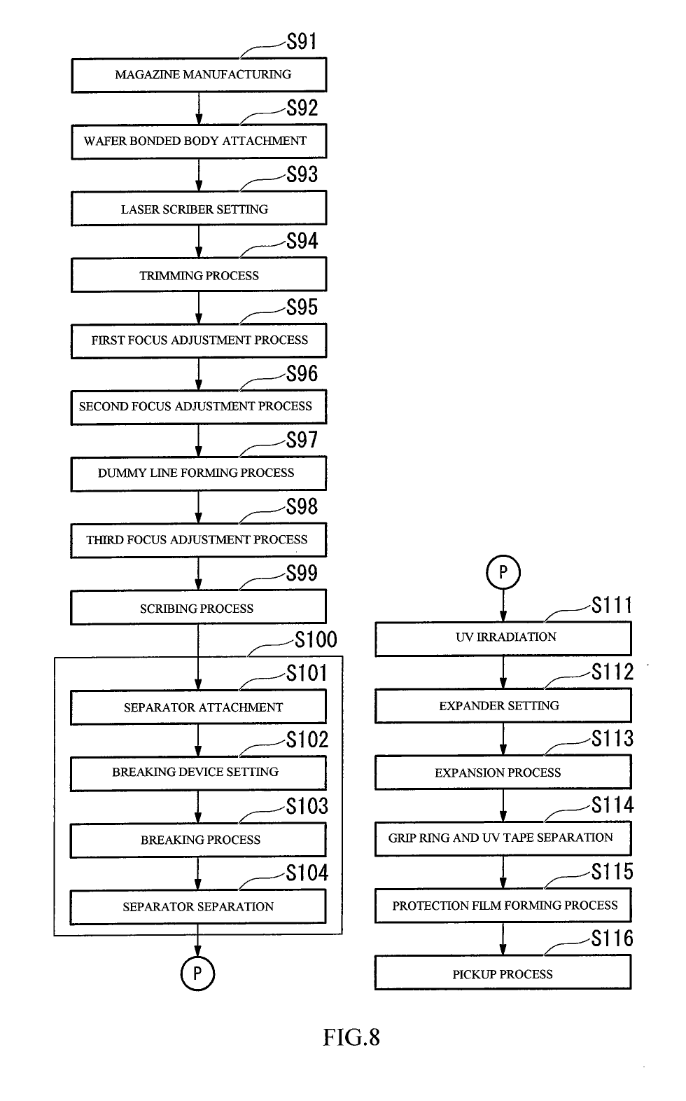

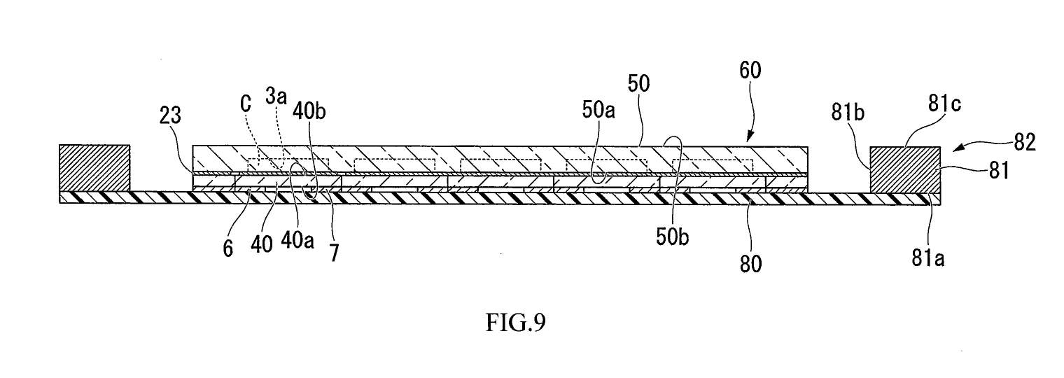

FIG. 8 is a flowchart illustrating a procedure of a dividing process of the wafer bonded body. Further, FIGS. 9 to 11, and FIGS. 13 to 16 are cross-sectional views illustrating states where the wafer bonded body is held in a magazine, which are process diagrams for illustrating the dividing process.

After the fine adjustment of the frequency ends, a dividing process is performed for cutting (tearing) the wafer bonded body 60 into individuals (S90).

In the dividing process (S90), as shown in FIGS. 8 and 9, firstly, a magazine 82 for holding the wafer bonded body 60 is manufactured using a UV tape 80 and a ring frame 81 (S91). The ring frame 81 is a member of a ring shape which is formed to have an inner diameter larger than the diameter of the wafer bonded body 60, and has the same thickness (length in the axial direction) as that of the wafer bonded body 60. Further, the UV tape 80 is a tape in which an ultraviolet curing resin, for example, an acrylic adhesive (adhesive layer) is coated on a flexible sheet material made of polyolefin. Specifically, UHP-1525M3 made by Denki Kagaku Kogyo, D510T made by Lintech Corp., or the like is preferably used as the UV tape 80. Further, it is preferable to use a relatively thick tape as the UV tape 80. Specifically, it is preferable to use the UV tape having a thickness of about 160 μm or more and about 180 μm or less. In the present embodiment, for example, it is preferable to use the UV tape 80 having a thickness of about 175 μm, for example.

The magazine 82 can be manufactured by attaching the UV tape 80 to the ring frame 81 from one surface 81a of the ring frame 81 to block an opening 81b. Further, in a state where the central axis of the ring frame 81 and the central axis of the wafer bonded body 60 coincide with each other, the wafer bonded body 60 is adhered to the adhered surface of the UV tape 80 (S92). Specifically, the side of the rear surface 40b of the wafer 40 for base substrates (external electrode side) is adhered to the adhered surface of the UV tape 80. Thus, the wafer bonded body 60 is in a state of being set in the opening 81b of the ring frame 81. In this state, the wafer bonded body 60 is transported to a laser scriber (not shown) (S93).

FIG. 17 is a diagram illustrating a trimming process, which is a plan view of a wafer for base substrates illustrating a state where a wafer for lid substrates of the wafer bonded body is removed.

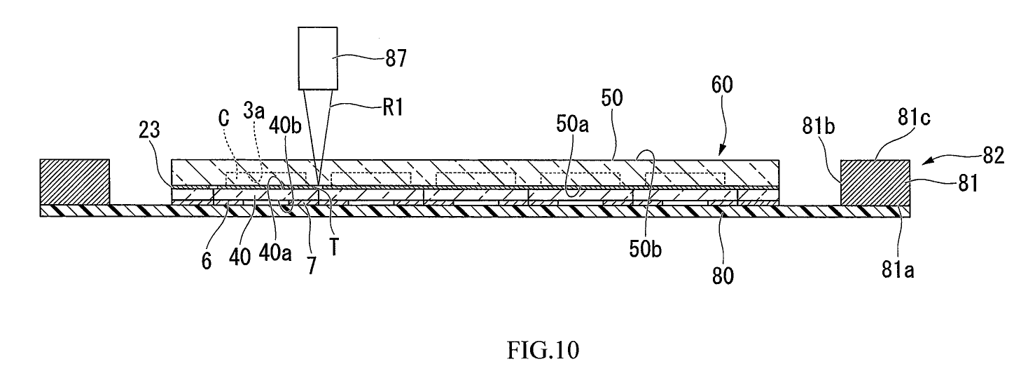

Here, as shown in FIGS. 10 and 17, the trimming process is performed for separating the bonding material 23 which bonds the wafer 50 for lid substrates and the wafer 40 for base substrates (S94). In the trimming process (S94), the bonding material 23 in an irradiation region of a laser light R1 is melted using a laser which emits light of an absorption band wavelength of the bonding material 23, for example, a first laser 87 including a second harmonic laser having a wavelength of 532 nm. In this case, the laser light R1 which is emitted from the first laser 87 is reflected by a beam scanner (galvanometer), and then is focused through an Fθ lens. Further, during irradiation of the focused laser light R1 from the side of the front surface (one surface of the bonding glass) 50b of the wafer 50 for lid substrates in the wafer bonded body 60, the laser light R1 and the wafer bonded body 60 are relatively moved in parallel. Specifically, the first laser 87 performs scanning along a partition wall which partitions each cavity C, that is, a contour line (planned cutting line) M (see FIG. 7) of the piezoelectric vibrator 1.

The spot diameter of the laser light R1 in the trimming process (S94) is set to about 10 μm or more and about 30 μm or less, for example. Further, as other conditions of the trimming process (S94), for example, it is preferable to set a processing point average output of the first laser 87 to about 1.0 W, a frequency modulation to about 20 kHz, and a scanning speed to about 200 mm/sec.

Thus, as the bonding material 23 on the contour line M absorbs the laser light R1 and is heated, the bonding material 23 is melted and shrinks outside from the irradiation region (contour line M) of the laser light R1. As a result, a trimming line T which is formed as the bonding material 23 is separated from the bonded surface is formed on the bonding surfaces of the wafers 40 and 50 (the rear surface 50a of the wafer 50 for lid substrates and the front surface 40a of the wafer 40 for base substrates).

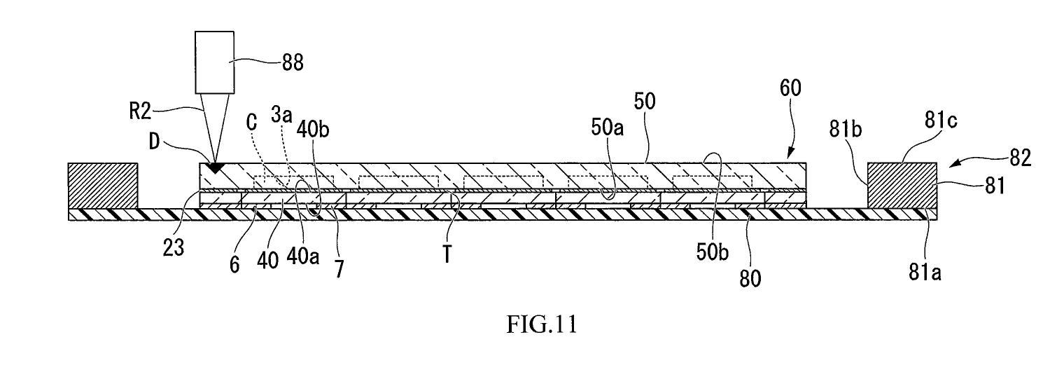

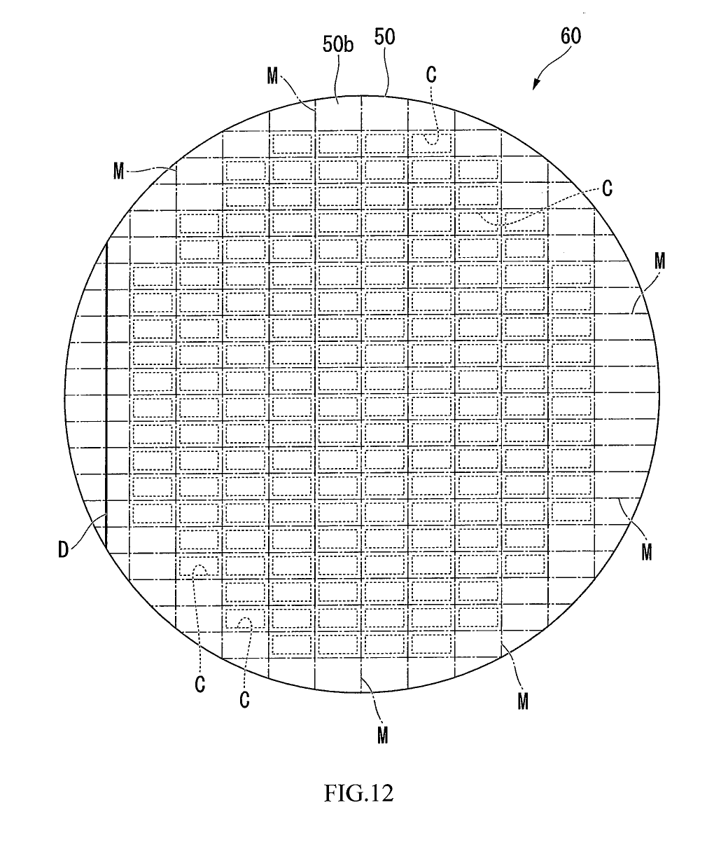

Here, as shown in FIG. 11, the above-described laser scriber includes a second laser 88 which is different from the first laser 87. The second laser 88 may be configured by a laser which emits an absorption band wavelength light of the wafer 50 for lid substrates (soda-lime glass), for example, a UV-Deep laser having a wavelength of 266 nm, and the second laser light R2 which is emitted from the second laser 88 is focused through an objective lens (not shown). The second laser 88 emits the second laser R2 to the wafer bonded body 60 from the side of the front surface 50b of the wafer 50 for lid substrates in the wafer bonded body 60.

Further, the laser scriber includes imaging means (not shown) for imaging the wafer bonded body 60 through the above-described objective lens and movement means for moving the objective lens with respect to the wafer bonded body 60 in the thickness direction.

Thus, in the present embodiment, a first focus adjustment process is performed for focusing the second laser light R2 on the bonding material 23 by imaging the bonding material 23 from the side of the front surface 50b of the wafer 50 for lid substrates after the above-described trimming process (S94) (S95). The focus adjustment of the second laser light R2 can be performed by moving the position of the objective lens by the movement means on the basis of contrast in the imaging result of the bonding material 23 which is imaged through the objective lens by the imaging means, for example.

By performing the first focus adjustment process (S95), the second laser light R2 is focused on the interface with the rear surface 40a of the wafer 40 for base substrates in the bonding material 23.

Thereafter, a second focus adjustment process is performed for moving the focus of the second laser light R2 toward the side of the front surface 50b of the wafer 50 for lid substrates along the thickness direction of the wafer bonded body 60 by an estimation thickness L of the wafer 50 for lid substrates (glass substrate which is irradiated) (S96). The movement of the focus of the second laser light R2 can be performed by moving the position of the objective lens by the movement means on the basis of the estimation thickness L, for example. As the estimation thickness L, for example, it is possible to adopt a design value of the thickness of the wafer 50 for lid substrates, or the like.

FIG. 12 is a diagram illustrating a dummy line forming process, which is a plan view of the wafer bonded body.

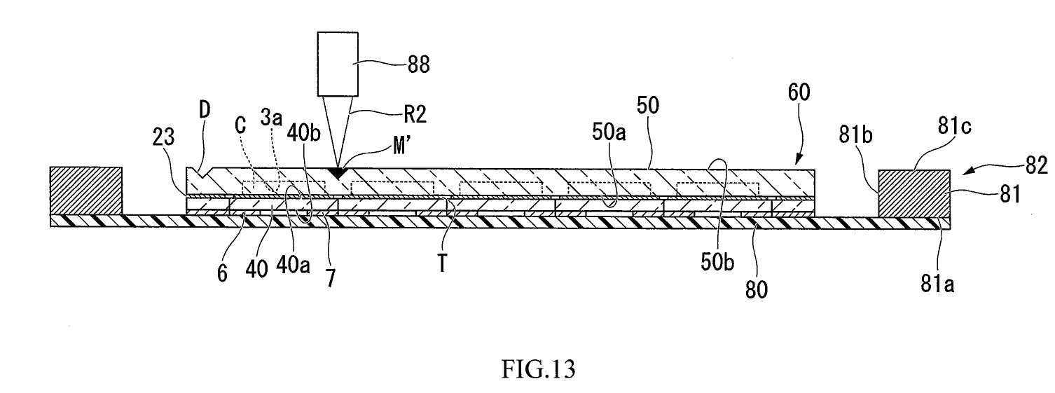

As shown in FIGS. 11 and 12, a dummy line forming process (detection target portion forming process) is performed for irradiating the wafer bonded body 60 with the second laser light R2 after the second focus adjustment process (S96) to form a dummy line (detection section) D on the front surface 50b of the wafer 50 for lid substrates (S97). Here, as shown in FIG. 13, the dummy line D is formed in a straight line shape which is parallel to the planned cutting line M. Further, here, in the front surface 50b of the wafer 50 for lid substrates, the dummy line D is formed in an outer peripheral portion excluding the central portion where the package 10 is formed.

Then, by imaging the dummy line D from the side of the front surface 50b of the wafer 50 for lid substrates, a third focus adjustment process is performed for refocusing the second laser light R2 on the dummy line D (S98). Here, the adjustment of the focus of the second laser light R2 can be performed by the same method as the first focus adjustment process as described above.

Further, as shown in FIG. 13, a front layer portion of the front surface 50b in the wafer 50 for lid substrates is irradiated by the laser light R2 to form a scribe line M′ on the wafer bonded body 60 (S95, scribing process). In the scribing process (S95), the front layer portion of the wafer 50 for lid substrates in the laser irradiation region is melted using the above-described second laser 88. Specifically, in a similar way to the trimming process (S94), the second laser 88 and the wafer bonded body 60 are relatively moved in parallel, and the second laser 88 performs scanning along the contour line M of the piezoelectric vibrator 1. Then, as the front layer portion of the wafer 50 for lid substrates adsorbs the laser light R2 and is heated, the wafer 50 for lid substrates is melted to form a scribe line M′ of a V groove shape. As described above, the first laser 87 and the second laser 88 perform scanning along the contour line M of each piezoelectric vibrator 1. Thus, the trimming line T and the scribe line M′ from which the bonding material 23 is separated are arranged to overlap with each other when viewing the wafer bonded body 60 from the thickness direction.

The scribe line M′ in the present embodiment has a width of about 14 μm and a depth of about 11 μm. It is preferable to constantly set the magnitude of the depth D with respect to the width W. As other conditions of the scribing process (S95), for example, it is preferable to set a processing point output of the second laser 88 to about 250 mW to 600 mW, pulse energy to about 100 μJ, processing threshold fluence to about 30 J/(cm2·pulse), scanning speed to about 40 mm/sec to 60 mm/sec, aperture to about 10 mm, and frequency to about 65 kHz.

Then, a debris removing process may be performed for removing debris generated when the scribe line M′ is formed.

Next, a cutting process is performed for cutting the wafer bonded body 60 in which the scribe line M′ is formed into individual packages 10 (S100).

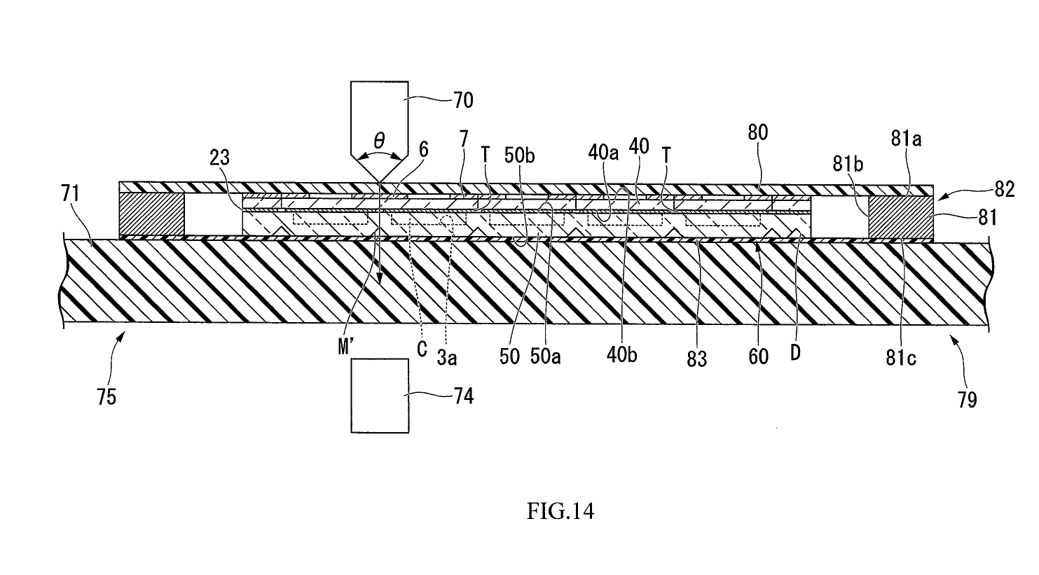

In the cutting process (S100), firstly, as shown in FIG. 14, a separator (protection sheet) 83 is adhered to the other surface 81c of the ring frame 81 so as to block the opening 81b (S101). The separator 83 protects the front surface 50b of the wafer 50 for lid substrates and blocks the ring frame 81 by the UV tape 80 and the separator 83 in a breaking process (S103), to thereby prevent fine dusts or the like generated at the time of breaking from being scattered into a breaking device 79 (which will be described later). Such a separator 83 is formed to have a thickness of 20 μm or more and 30 μm or less by a polyethylene terephthalate film (so-called PET material) or the like, for example. In the present embodiment, the separator 83 having a thickness of 25 μm is used. If the thickness of the separator 83 is thinner than 20 μm, in the breaking process (S103) (which will be described later), the separator 83 may be cut together with the wafer bonded body 60, which is not preferable. On the other hand, if the thickness of the separator 83 is thicker than 30 μm, a tear stress which acts on the wafer bonded body 60 from the separator 83 is alleviated by the separator 83. Thus, the wafer bonded body 60 is not smoothly cut, and thus, the surface accuracy of the cut surface may be reduced, which is not preferable.

Further, the wafer bonded body 60 is held in the opening 81b of the ring frame 81 in a state of being supported between the UV tape 80 and the separator 83. In this state, the wafer bonded body 60 is transported into the breaking device 79 (S102).

The breaking device 79 includes a stage 75 for mounting the wafer bonded body 60, a cutting blade 70 for cutting the wafer bonded body 60, and a CCD camera (imaging means) 74 which is disposed below the stage 75 (on the side which is opposite to the mounting surface of the wafer bonded body 60). The stage 75 is configured by a silicon bar 71. The silicon bar 71 is formed of an optically transparent material in a bed shape. Further, the cutting blade 70 has a blade length which is formed to be longer than the diameter of the wafer bonded body 60, and a knife angle θ of about 60° to about 90°, for example.

In this case, in the breaking device 79, the wafer bonded body 60 is set in a state where the front surface 50b of the wafer 50 for lid substrates is directed to the stage 75. That is, the wafer bonded body 60 is mounted on the silicon rubber 71 through the separator 83.

Further, a breaking process is performed for applying a tear stress to the wafer bonded body 60 which is set in the breaking device 79 (S103). In the breaking process (S103), firstly, alignment is performed so that the cutting blade 70 is disposed on the scribe line M′ (trimming line T). Specifically, the position of the scribe line M′ on the wafer 50 for lid substrates is detected by the CCD camera 74 which is disposed below the stage 75, and the cutting blade 70 moves along the surface direction of the wafer bonded body 60 on the basis of the detection result. Thus, it is possible to perform the alignment of the cutting blade 70. Thereafter, the cutting blade 70 moves (descends) in the thickness direction of the wafer bonded body 60, and the blade of the cutting blade 70 is pressed against the rear surface 40b of the wafer 40 for base substrates. Thereafter, the cutting blade 70 moves by a predetermined stroke (for example, about 50 μm) to push the cutting blade 70 along the thickness direction of the wafer bonded body 60. Here, a predetermined load (for example, 10 kg/inch) is applied to the wafer bonded body 60.

Thus, a crack is generated in the wafer bonded body 60 along the thickness direction, and the wafer bonded body 60 is cut to be folded along the scribe line M′ which is formed on the wafer 50 for lid substrates. Here, since the wafer bonded body 60 is set on the silicon rubber 71 of the stage 75, the breaking device 79 according to the present embodiment pushes the cutting blade 70 into the wafer bonded body 60 to elastically deform the silicon rubber 71. Accordingly, the wafer bonded body 60 is slightly bended to be curved toward the stage 75 along the front surface of the silicon rubber 71. Thus, the tear stress applied to the wafer bonded body 60 is easily concentrated on the bottommost portion of the scribe line M′. Further, the load due to the cutting blade 70 which acts on a region other than a contact point of the cutting blade 70 and the wafer bonded body 60 is escaped (absorbed or attenuated) to the silicon rubber 71.

Thus, in a case where the load is applied to the wafer bonded body 60, the bottommost portion of the scribe line M′ becomes a starting point of generation of the crack, and the crack is easily propagated toward the rear surface 40b of the wafer 40 for base substrates from the front surface 50a of the wafer 50 for lid substrates along the thickness direction, in the wafer bonded body 60. As a result, the wafer bonded body 60 is cut to be folded along the groove. Further, the above-described tear stress is a tensile stress generated in a direction separating from the scribe line M′ (direction from which the respective packages 10 are separated from each other).

Further, by pressing the cutting blade 70 for each scribe line M′ by the above-described method, it is possible to separate the wafer bonded body 60 into the packages in a batch for each contour line M. Thereafter, the separator 83 which is attached to the wafer bonded body 60 is separated (S104).

Next, the UV tape 80 of the magazine 82 is irradiated with UV to slightly reduce the adhesive force of the UV tape 80 (S111). In this state, the wafer bonded body 60 is still in the state of being attached to the UV tape 80.

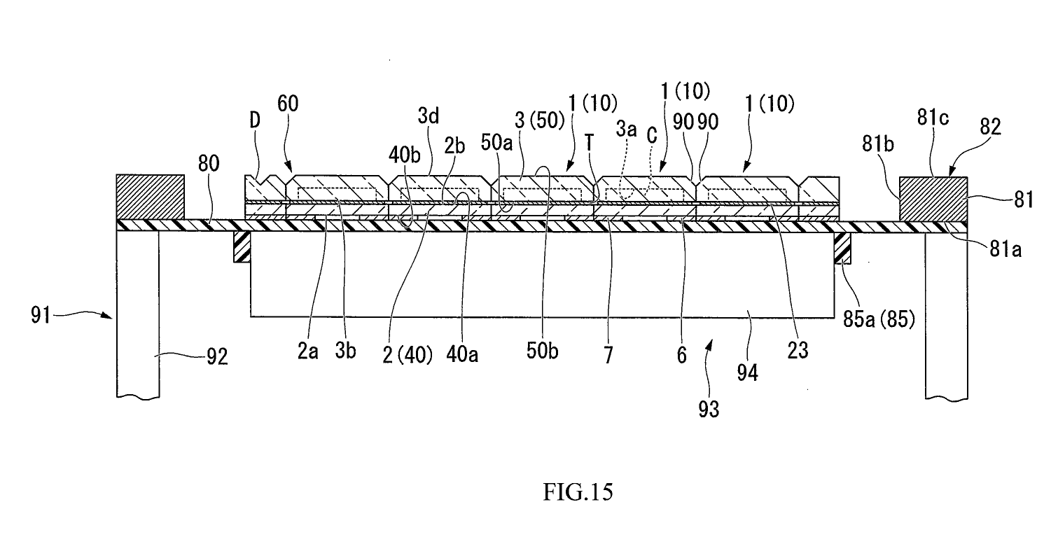

Next, as shown in FIG. 15, in order to perform an expansion process (S113) (which will be described later), the wafer bonded body 60 is transported into an expander 91 (S112). Firstly, the expander 91 will be described.

The expander 91 includes a base ring 92 of a circular ring shape in which the ring frame 81 is set, and a disc-like heater panel 93 which is disposed inside the base ring 92 and is formed to be larger in size than the wafer bonded body 60. In the heater panel 93, a heat transfer type heater (not shown) is mounted on a base plate 94 in which the wafer bonded body 60 is set, and the central axis of the heater panel 93 is disposed to coincide with the central axis of the base ring 92. Further, the heater panel 93 is formed to be able to move along the axial direction by drive means (not shown). Although not shown, the expander 91 also includes a holding member which holds the ring frame 81 which is set on the base ring 92 between the holding member and the base ring 92.

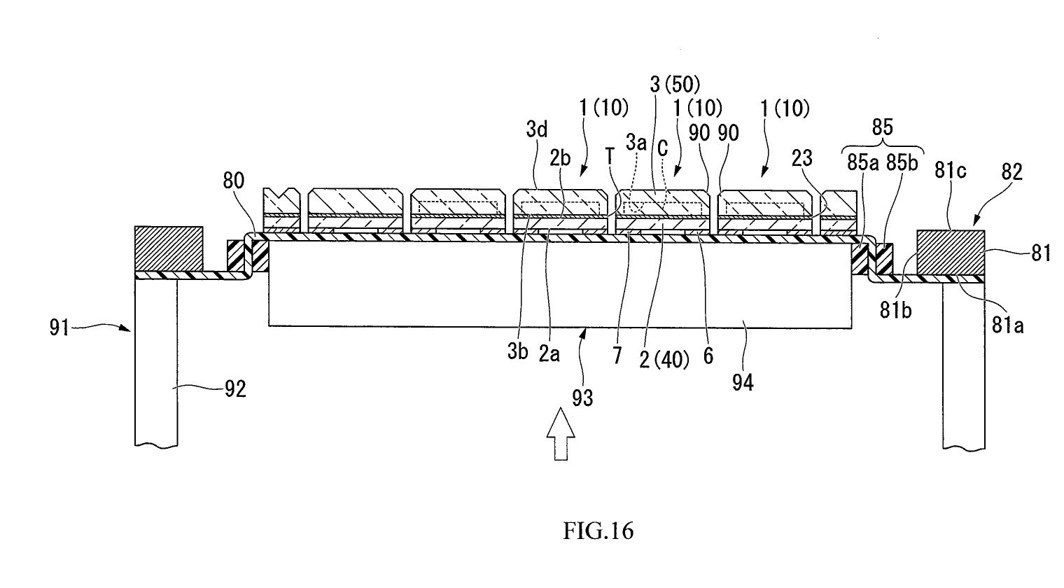

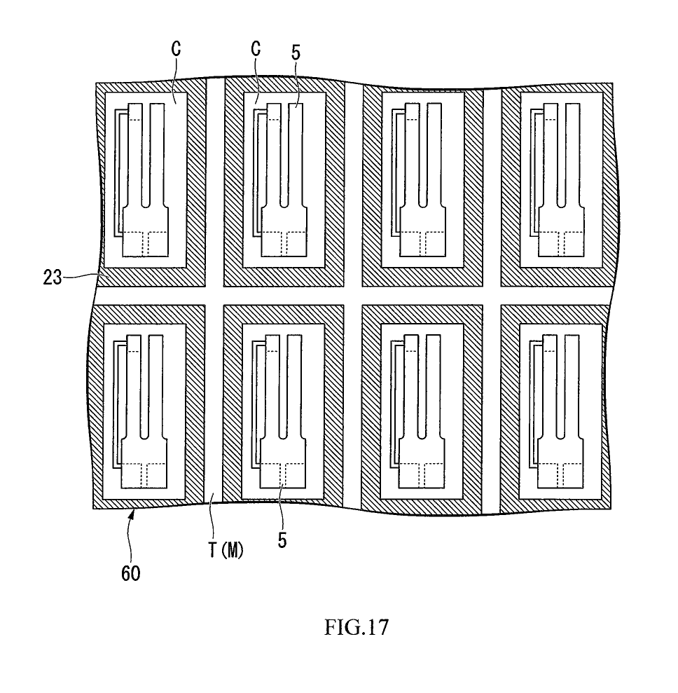

In order to perform the expansion process (S113) using such a device, before the wafer bonded body 60 is set in the expander 91, an inner ring 85a among grip rings 85 (which will be described later) is firstly set outside the heater panel 93. Here, the inner ring 85a is set to be fixed to the heater panel 93 and move together with the movement of the heater panel 93. The grip rings 85 are resin rings which have an inner diameter which is larger than the outer diameter of the heater panel 93 and is smaller than the inner diameter of the opening 81b of the ring frame 81, and include the inner ring 85a and an outer ring 85b (see FIG. 16) having an inner diameter which is the same as the outer diameter of the inner ring 85a. That is, the inner ring 85a is inserted in the outer ring 85b.

Thereafter, the wafer bonded body 60 which is fixed to the magazine 82 is set in the expander 91. Here, the wafer bonded body 60 is set so that the side of the UV tape 80 is directed toward the heater panel 93 and the base ring 92. Specifically, in a state where the rear surface 40b of the wafer bonded body 60 and the heater panel 93 face each other and one surface 81a of the ring frame 81 and the base ring 92 face each other, the wafer bonded body 60 is set in the expander 91.

Thus, the wafer bonded body 60 is set on the heater panel 93 through the UV tape 80. Further, the ring frame 81 is held between the base ring 92 and the holding member (not shown) by the holding member.

Next, the UV tape 80 is heated to a temperature of 50° C. or more by a heater of the heater panel 93. As the UV tape 80 is heated to the temperature of 50° C. or more, the UV tape 80 is softened to easily extend. Further, as shown in FIG. 16, in a state where the UV tape 80 is heated, the heater panel 93 is raised together with the inner ring 85a (see an arrow in FIG. 16). Here, since the ring frame 81 is held between the base ring 92 and the holding member, the UV tape 80 extends outside in the radial direction of the wafer bonded body 60. Thus, the packages 10 which are adhered to the UV tape 80 are separated and a space between the adjacent packages 10 is enlarged. Further, in this state, the outer ring 85b is set outside the inner ring 85a. Specifically, in a state where the UV tape 80 is disposed between the inner ring 85a and the outer ring 85b, both the rings are engaged with each other. Thus, the UV tape 80 is held in the grip rings 85 in the extended state. Then, the UV tape 80 outside the grip ring 85 is cut, and the ring frame 81 and the grip rings 85 are separated (S114).

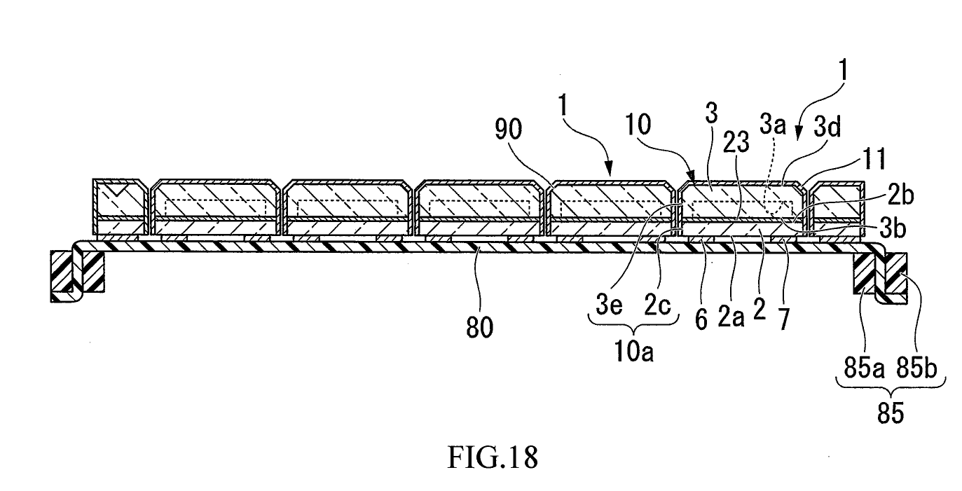

FIG. 18 is a diagram illustrating a protection film forming process, which is a cross-sectional view illustrating a state where a plurality of piezoelectric vibrators is attached to a UV tape.

Next, as shown in FIG. 18, a protection film forming process (S115) is performed for coating the package 10 by a protection film 11. Specifically, firstly, the plurality of the packages 10 is transported into a chamber of a sputtering device in the state of being attached to the UV tape 80, and is set so that the lid substrate 3 faces a film formation material (target) of the protection film 11. By performing sputtering in this state, atoms which are sputtered out of the film formation material are attached onto the front surface 3d of the lid substrate 3 and the side surface 10a of the package 10. Thus, the protection film 11 is formed over the entire region which ranges from the front surface 3d of the lid substrate 3 to the side surface 10a of the package 10.

In this case, since the bonding material 23 is exposed to the side surface 10a of the package 10, in order to form the protection film 11 to cover the bonding material 23, it is necessary to separately dispose all the packages 10 so that the side surfaces 10a are exposed.

Thus, according to the present embodiment, since the protection film forming process is performed using the state where the plurality of packages 10 is separated in the expansion process, it is not necessary to separately re-dispose all the packages 10, thereby enhancing the manufacturing efficiency. That is, since the protection film 11 can be formed in a state where the space between the respective packages 10 is secured, it is possible to uniformly form the protection film 11 with respect to the bonding material 23 which is exposed from between the base substrate 2 and the lid substrate 3 in each package 10.

Further, since it is possible to form the protection film 11 with respect to the divided plurality of packages 10 in a batch by performing sputtering in a state where the plurality of packages 10 is attached to the UV tape 80 which is expanded, it is possible to enhance the manufacturing efficiency compared with a case where the protection film 11 is individually formed in the package 10. Further, it is possible to suppress the movement of the packages 10 in transportation to the sputtering device or in film formation.

Further, by performing sputtering from the side of the lid substrate 3 in a state where the UV tape 80 is attached to the side of the rear surface 2a of the base substrate 2, it is possible to suppress the film formation material from entering into the side of the rear surface 2a of the base substrate 2. Thus, it is possible to suppress the film formation material from being attached to the external electrodes 6 and 7, and it is thus possible to suppress the space between the external electrodes 6 and 7 from being bridged by the protection film 11. Thus, even in a case where a conductive metal material such as Cr is used for the protection film 11, it is possible to suppress a short circuit between the external electrodes 6 and 7. Further, in the present embodiment, since the side surfaces of the external electrodes 6 and 7 are positioned on the inner side with reference to the side surface 2c of the base substrate 2, the circumferential end portion of the protection film 11 and the external electrodes 6 and 7 are separately disposed with the gap portion 12 (see FIG. 2) being interposed therebetween. Thus, even though the film formation material slightly enters into the side of the rear surface 2a of the base substrate 2, it is possible to suppress the protection film 11 and the external electrodes 6 and 7 from being continuously bridged.

In the present embodiment, since the film formation material is disposed to face the front surface 3d of the lid substrate 3, the front surface 3d of the lid substrate 3 is easily attached to the film formation material, compared with the side surface 10a of the package 10. Specifically, the film formation speed ratio of the front surface 3d of the lid substrate 3 and the side surface 10a of the package 10 becomes about 3:1 to 4:1. In order to reduce the film formation speed ratio, it is preferable to perform sputtering while rotating the grip rings 85 (package 10).

Next, a pickup process is performed for extracting the piezoelectric vibrator 1 in which the protection film 11 is formed. In the pickup process (S116), the UV tape 80 is irradiated with UV to reduce the adhesion force of the UV tape 80. Thus, the piezoelectric vibrator 1 is separated from the UV tape 80. Thereafter, the position of each piezoelectric vibrator 1 is ascertained by image recognition or the like, and the piezoelectric vibrator 1 is absorbed by a nozzle or the like to extract the piezoelectric vibrator 1 which is separated from the UV tape 80. In this way, by separating the piezoelectric vibrator 1 from the UV tape 80 due to the UV irradiation of the UV tape 80, it is possible to easily extract the diced piezoelectric vibrator 1. In the present embodiment, since the division is performed along the scribe line M′ of the wafer 50 for lid substrates in the above-described breaking process (S103), the chamfer portion 90, in which the C chamfer is formed by the scribe line M′ is formed, on the upper edge of the lid substrate 3 of the divided piezoelectric vibrator 1.

Hereinbefore, it is possible to manufacture at one time the plurality of piezoelectric vibrators 1 of a surface mount type of a two-layer structure shown in FIG. 1, in which the piezoelectric vibrating piece 5 is sealed in the cavity C which is formed between the base substrate 2 and the lid substrate 3 which are anodically bonded to each other. Thus, the dividing process ends.

Thereafter, an internal electric characteristic inspection is performed (S110). That is, the resonant frequency, resonant resistance value, drive level characteristics (excitation power dependency of the resonant frequency and resonant resistance value), and the like of the piezoelectric vibrating piece 5 are measured to be checked. Further, insulating resistance characteristics and the like are also checked. Further, an appearance inspection of the piezoelectric vibrator 1 is performed to finally check the size, quality and the like.

FIG. 19 is a diagram illustrating a marking process, which is an appearance perspective view of the piezoelectric vibrator corresponding to FIG. 1.

The electrical characteristic inspection and the appearance inspection are completed, and then, the marking 13 is finally performed with respect to the piezoelectric vibrator 1 which passes the inspections (S120). As shown in FIG. 19, the marking 13 is engraved for the product type, product number, date of packing and the like, by removing the protection film 11 on the front surface 3d of the lid substrate 3 by irradiating the front surface 3d of the lid substrate 3 with the laser light R3 in the vertical direction. In this way, by forming the marking 13 by removing the protection film 11, it is not necessary to separately form a plating film for forming the marking 13, thereby enhancing the manufacturing efficiency.

In the marking process (S120), the output of the laser light R3 is preferably adjusted to such a degree that it penetrates only the protection film 11. Thus, it is possible to suppress the laser light R3 from penetrating the base substrate 2 to reach the cavity C. That is, it is possible to suppress the piezoelectric vibrating piece 5 from being irradiated with the laser light R3 to suppress damage to the piezoelectric vibrating piece 5, and it is thus possible to suppress the electric characteristics (frequency characteristics) of the piezoelectric vibrating piece 5 from being affected.

Further, in order to reliably suppress the transmission of the laser light R3 into the base substrate 2, it is preferable to use a laser having a high absorption factor in the glass material. As such a laser, for example, it is possible to use a CO₂ laser of a wavelength of 10.6 μm, a fourth harmonic laser of a wavelength of 266 nm, or the like. Further, by using the CO₂ laser having a relatively long wavelength among these lasers, it is possible to reliably suppress damage to the base substrate 2.

As described above, in the present embodiment, since the second laser light R2 is correctly focused on the bonding material 23 in the first focus adjustment process (S95) and the dummy line D is then formed on the front surface 50b of the wafer 50 for lid substrates through the second focus adjustment process (S96), it is possible to reliably form the dummy line D on the front surface 50b of the wafer 50 for lid substrates, without acting on the thickness of the wafer 40 for base substrates or the thickness of the bonding material 23. Accordingly, in the scribing process (S99), by forming the scribe line M′ using the second laser light R2 which is focused on the dummy line D in the third focus adjustment process (S98), it is possible to form the scribe line M′ on the front surface 50b of the wafer 50 for lid substrates with high accuracy.

In this way, without any process of measuring the thickness of the wafer bonded body 60 one by one, it is possible to form the scribe line M′ with high efficiency.

Further, since the bonding material 23 which bonds the respective wafers 40 and 50 to each other is imaged in the first focus adjustment process (S95), it is not necessary to add a new component to the wafer bonded body 60 in order to perform the first focus adjustment process (S95), and thus, it is possible to suppress the structure of the wafer bonded body 60 from being complicated and to cut the wafer bonded body 60 with high efficiency.

Further, by imaging the dummy line D which is formed in the dummy line forming process (S97), it is possible to correctly and smoothly refocus the second laser light R2 on the dummy line D. Accordingly, differently from the case where the imaging is performed using frictional traces or foreign substances as an indicator, the above-described effects are remarkable.

Further, since it is possible to continuously perform the first focus adjustment process (S95) to the scribing process (S99) as a series of flows, it is not necessary to form in advance a configuration such as a dummy line D on the wafer bonded body 60, and it is thus possible to cut the wafer bonded body 60 with high efficiency.

Further, since the dummy line D is formed in the straight line shape in the dummy line forming process (S97), in the third focus adjustment process (S98), it is possible to refocus the second laser light R2 in a plurality of portions along the extending direction of the dummy line D, and thus, it is possible to form the scribe line M′ on the front surface 50b of the wafer 50 for lid substrates with higher accuracy.

Further, since the dummy line D is formed in the straight line shape which is parallel to the planned cutting line M, it is possible to simplify the device configuration of the second laser 88.

Further, since the dummy line D is formed in the portion other than the package forming region on the front surface 50b of the wafer 50 for lid substrates in the dummy line forming process (S97), it is possible to reliably enhance the yield ratio.

Further, in the present embodiment, the breaking process is performed in a state where the wafer bonded body 60 is set on the silicon rubber 71 of the stage 75.

According to this configuration, as the cutting blade 70 is pressed into the wafer bonded body 60 along the scribe line M′, the silicon rubber 71 is elastically deformed and the wafer bonded body 60 is slightly deformed to bend toward the silicon rubber 71 according to the elastic deformation of the silicon rubber 71. Thus, the tear stress applied to the wafer bonded body 60 is easily concentrated on the bottommost portion of the scribe line M′.

As a result, in a case where the tear stress is applied to the wafer bonded body 60, the bottommost portion of the scribe line M′ becomes a starting point of generation of the crack, and the crack is easily propagated toward the rear surface 40b of the wafer 40 for base substrates from the front surface 50a of the wafer 50 for lid substrates along the thickness direction, in the wafer bonded body 60. Thus, the wafer bonded body 60 is cut to be folded along the scribe line M′.

Accordingly, it is possible to smoothly and easily cut the wafer bonded body 60 along the scribe line M′. Thus, it is possible to suppress generation of crush and to suppress generation of chippings, to thereby obtain a reliable cut surface without traces of residual stress. Thus, it is possible to cut the piezoelectric vibrator 1 into a desired size from the wafer bonded body 60. As a result, it is possible to increase the number of piezoelectric vibrators 1 with high quality extracted from one wafer bonded body 60, thereby enhancing the yield ratio.

Further, in the breaking process, by moving the cutting blade 70 to press it in the thickness direction of the wafer bonded body 60 in a state where the tip end of the cutting blade 70 is in contact with the rear surface 40b of the wafer 40 for base substrates, it is possible to reliably apply the tear stress along the scribe line M′. Thus, it is possible to facilitate the crack propagation in the thickness direction of the wafer bonded body 60. Further, compared with a case where a cutting blade is dropped to a wafer bonded body in the related art, it is possible to prevent generation of chippings or the like due to impact between the cutting blade and the wafer bonded body 60. Accordingly, it is possible to obtain a more reliable cut surface.

Further, when the cutting blade 70 is in contact with the wafer bonded body 60 in the present embodiment, the cutting blade 70 is positioned on the basis of the position of the scribe line M′ detected by the CCD camera 74.

According to this configuration, it is possible to reliably assign the tear stress along the scribe line M′ by aligning the scribe line M′ and the cutting blade 70, and it is thus possible to smoothly and easily cut the wafer bonded body 60.

In the present embodiment, since the separator 83 of the magazine 82 is disposed between the wafer bonded body 60 and the silicon rubber 71, in a case where fine dusts or the like are scattered in cutting the wafer bonded body 60, it is possible to capture the dusts or the like by the silicon rubber 71.

As a result, it is possible to prevent the wafer bonded body 60 which is mounted on the silicon rubber 71 from being in contact with the dusts or the like and being damaged. Further, since the wafer bonded body 60 can be mounted in a state of being constantly in close contact with the silicon rubber 71, it is possible to prevent slippage or the like in mounting the wafer bonded body 60, and to reliably cut the wafer bonded body 60 along the thickness direction.

Further, since the thickness of the UV tape 80 is set to 160 μm or more, the UV tape 80 is hardly broken in the expansion process (S113). Thus, without exchange of the UV tape 80 used in the scribing process (S95) or the like, it is possible to use the UV tape 80 in the expansion process (S113) as it is. That is, before the expansion process (S113), it is not necessary to perform an exchange process or the like of the UV tape 80, and it is thus possible to prevent decrease in the manufacturing efficiency and increase in the manufacturing cost.

On the other hand, by using the UV tape 80 which is formed to have the thickness of 180 μm or less, it is possible to suppress the force necessary for extending the UV tape 80, thereby enhancing the manufacturing efficiency. Further, since the UV tape 80 is easily available in the market, it is possible to reduce the material cost necessary for the UV tape 80.

Further, in the present embodiment, by performing the expansion process (S113) after the wafer bonded body 60 is divided, it is possible to equivalently enlarge the interval between adjacent piezoelectric vibrators 1 (packages 10), and thus, it is possible to reliably separate the adjacent piezoelectric vibrators 1. Accordingly, when the piezoelectric vibrators 1 are extracted from the UV tape 80 after the expansion process (S113), the divided piezoelectric vibrators 1 are easily recognized (the recognition accuracy is enhanced), and it is thus possible to easily extract the respective piezoelectric vibrators 1.

Further, when the piezoelectric vibrators 1 are extracted from the UV tape 80 after the expansion process (S113), it is possible to prevent the piezoelectric vibrator 1 from being in contact with the adjacent piezoelectric vibrator 1 and to prevent generation of chippings due to contact of the piezoelectric vibrators 1, to thereby prevent breaking of the piezoelectric vibrators 1. Accordingly, it is possible to increase the number of the piezoelectric vibrators 1 with high quality extracted from one sheet of the wafer bonded body 60, thereby enhancing the yield ratio.

By forming the trimming line T by separating the bonding material 23 on the contour line M before the scribing process (S95), it is possible to promote the crack propagation in the thickness direction of the wafer bonded body 60 at the breaking time and to prevent the crack propagation in the surface direction of the wafer bonded body 60.

Further, the lid substrate 3 of the piezoelectric vibrator 1 according to the present embodiment has the chamfer portion 90 in its edge portion.

According to this configuration, in the pickup process (S110), when the divided piezoelectric vibrator 1 is extracted, even in a case where a tool for extracting the piezoelectric vibrator 1 is in contact with the corner portion of the piezoelectric vibrator 1, it is possible to suppress generation of chippings due to the contact. Thus, the piezoelectric vibrator 1 is prevented from being broken due to the chippings.

Thus, it is possible to secure air-tightness in the cavity C, to thereby provide a piezoelectric vibrator 1 with superior vibration characteristics and high reliability.

Since the chamfer portion 90 is automatically formed by the cutting along the scribe line M′ after the scribe line M′ is formed by the second laser 88, it is not necessary to individually form the chamfer portion 90 in the piezoelectric vibrator 1 after cutting. As a result, it is possible to suppress the cost increase, compared with a case where the chamfer portion is formed in a separation process, thereby enhancing the working efficiency.

Further, in the present embodiment, the bonding material 23 is covered by the protection film 11 which is higher in corrosion resistance than the bonding material 23, on the outer surface of the package 10.

According to this configuration, since the bonding material 23 is covered by the protection film 11, the bonding material 23 is not exposed to the outside. Thus, it is possible to suppress the bonding material 23 from being in contact with air and to suppress corrosion of the bonding material 23 due to moisture or the like in air. In this case, since the protection film 11 is configured by a material which is higher in corrosion resistance than the bonding material 23, it is possible to suppress the bonding material 23 from being exposed due to corrosion of the protection film 11, and thus, it is possible to reliably suppress corrosion of the bonding material 23. Thus, it is possible to maintain the air-tightness in the cavity C in a stable state over a long time, thereby providing the piezoelectric vibrator 1 with superior vibration characteristics and high reliability.

### (Oscillator)

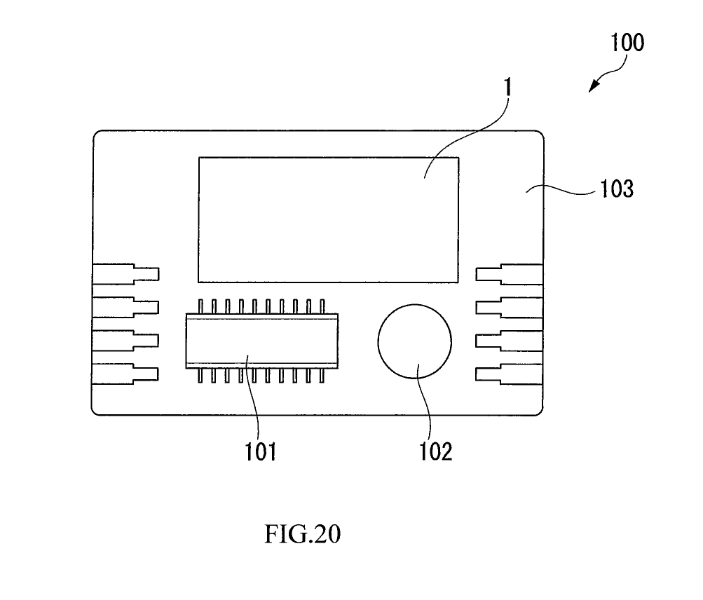

Next, an oscillator according to an embodiment of the invention will be described with reference to FIG. 20.

As shown in FIG. 20, an oscillator 100 according to the present embodiment is configured as an oscillator element in which the piezoelectric vibrator 1 is electrically connected to an integrated circuit 101. The oscillator 100 includes a substrate 103 on which an electronic component 102 such as a capacitor is mounted. The above-mentioned integrated circuit 101 for oscillator is mounted on the substrate 103, and the piezoelectric vibrator 1 is mounted in the vicinity of the integrated circuit 101. The electronic component 102, the integrated circuit 101 and the piezoelectric vibrator 1 are electrically connected to each other by a wiring pattern (not shown). Each component is molded by resin (not shown).

In the oscillator 100 with such a configuration, if a voltage is applied to the piezoelectric vibrator 1, the piezoelectric vibrating piece 5 in the piezoelectric vibrator 1 vibrates. This vibration is converted into an electric signal by piezoelectric characteristics of the piezoelectric vibrating piece 5 and is input to the integrated circuit 101 as an electric signal. The input electric signal is subject to a variety of processes in the integrated circuit 101 and is then output as a frequency signal. Thus, the piezoelectric vibrator 1 functions as an oscillator element.

Further, by selectively setting an RTC (real time clock) module or the like in the configuration of the integrated circuit 101 according to demands, it is possible to add a function of controlling an operation date or time of the corresponding device or an external device or a function of providing time, calendar or the like, in addition to the oscillator having a simple time piece function.

As described above, according to the oscillator 100 of the present embodiment, since the piezoelectric vibrator 1 with high quality is provided, it is possible to achieve the oscillator 100 with high quality. In addition, it is possible to obtain a frequency signal with high accuracy which is stable over a long time.

### (Electronic Apparatus)

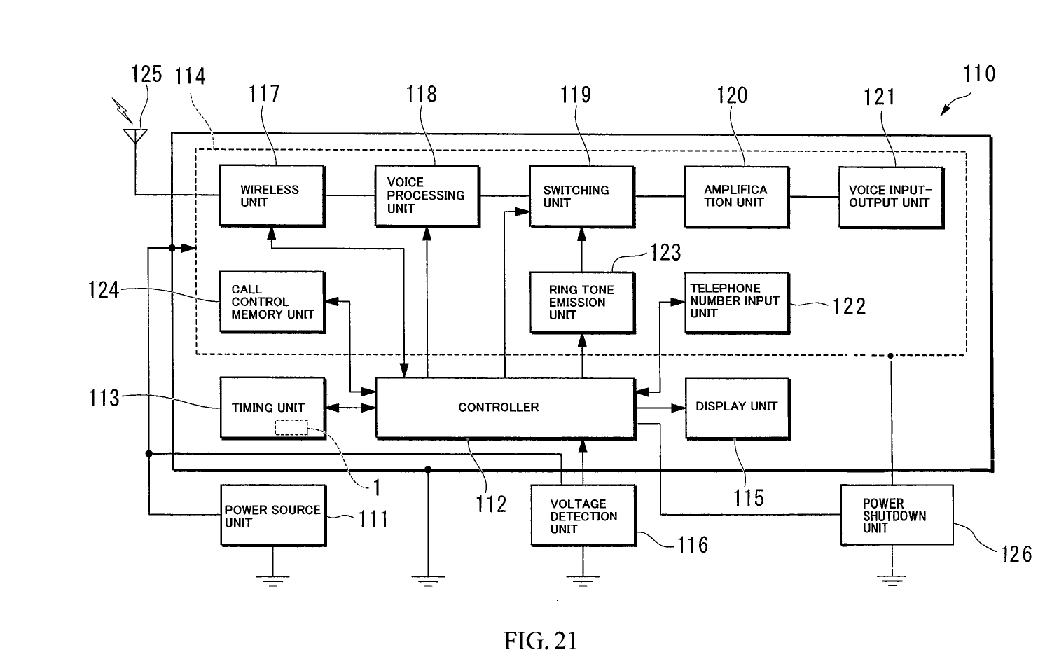

Next, an electronic apparatus according to an embodiment of the invention will be described with reference to FIG. 21. As the electronic apparatus, a portable information device 110 having the above-described piezoelectric vibrator 1 will be described as an example. Firstly, the portable information device 110 of the present embodiment is represented as a mobile phone, which is obtained by developing and modifying a wrist watch in the related art. Its appearance is similar to a wrist watch, in which a liquid crystal display panel is disposed in a portion corresponding to a dial plate. A current time or the like can be displayed on its screen. Further, in a case where the electronic apparatus is used as a communication device, the electronic apparatus is capable of communication in a similar way to a mobile phone in the related art while being taken off from the wrist, through a speaker and a microphone built in an inner portion of the band. However, compared with the mobile phone in the related art, the electronic apparatus is considerably minimized and light-weighted.

Next, a configuration of the portable information device 110 according to the present embodiment will be described. The portable information device 110 includes the piezoelectric vibrator 1 and a power source 111 for supplying electric power, as shown in FIG. 21. The power source 111 is a secondary lithium battery, for example. In the power source 111, a control section 112 which performs a variety of controls, a timer section 113 which performs time counting or the like, a communicating section 114 which performs communication with the outside, a display section 115 which displays various information, and a voltage detecting section 116 which detects voltages of the respective functional sections are connected to each other in parallel. Further, electric power is supplied to the respective functional sections by the power source 111.

The control section 112 performs an operation control of the entire system, such as transmission and reception of sound data or measurement or display of the current time by controlling the respective functional sections. Further, the control section 112 includes a ROM in which a program is written in advance, a CPU which reads the program written in the ROM for execution, a RAM which is used as a work area of the CPU, and the like.

The timer section 113 includes an integrated circuit in which an oscillation circuit, a register circuit, a counter circuit, an interface circuit and the like are built, and the piezoelectric vibrator 1. If a voltage is applied to the piezoelectric vibrator 1, the piezoelectric vibrating piece 5 vibrates. This vibration is converted into an electric signal by the piezoelectric characteristic of quartz crystal, and is input to the oscillation circuit as an electric signal. The output of the oscillation circuit is binarized and is counted by the register circuit and the counter circuit. Further, signals are transmitted to or received from the control section 112 through the interface circuit, and the current time, current date, calendar information or the like is displayed on the display section 115.

The communicating section 114 has the same function as that of a mobile terminal in the related art, which includes a radio section 117, a sound processing section 118, a switching section 119, an amplifying section 120, a sound input and output section 121, a telephone number input section 122, a ringtone generating section 123 and a call control memory section 124.

The radio section 117 transmits or receives a variety of data such as sound data to or from a base station through an antenna 125. The sound processing section 118 encodes and decodes the sound signal input from the radio section 117 or the amplifying section 120. The amplifying section 120 amplifies the signal input from the sound processing section 118 or the sound input and output section 121 to a predetermined level. The sound input and output section 121 includes a speaker, a microphone or the like, which amplifies the ringtone or receiver sound or collects sound.

Further, the ringtone generating section 123 generates a ringtone according to a call from the base station. The switching section 119 switches the amplifying section 120 which is connected to the sound processing section 118 to the ringtone generating section 123 only in reception, and thus, the ringtone generated in the ringtone generating section 123 is output to the sound input and output section 121 through the amplifying section 120.

The call control memory section 124 stores a program relating to an outgoing and incoming call control of communication. Further, the telephone number input section 122 includes numeric keys of 0 to 9 and other keys, for example, in which the telephone number or the like of the called party is input by pressing these numeric keys.

In a case where the voltage applied to each functional section of the control section 112 or the like by the power source 111 is less than a predetermined value, the voltage detecting section 116 detects the voltage drop and notifies the result to the control section 112. Here, the predetermined voltage value is a value which is set in advance as a minimum voltage necessary for stably operating the communicating section 114, and for example, is about 3V. The control section 112 which receives the notification of the voltage drop from the voltage detecting section 116 restricts the operations of the radio section 117, the sound processing section 118, the switching section 119 and the ringtone generating section 123. Particularly, the operation of the radio section 117 requiring a large amount of power consumption should be necessarily stopped. Further, the information that the communicating section 114 cannot be used due to lack of the remaining battery level is displayed on the display section 115.

That is, the operation of the communicating section 114 is restricted by the voltage detecting section 116 and the control section 112, which can be displayed on the display section 115. This display may be a text message, but an “x” mark may be added as a more intuitive display to a telephone icon displayed on an upper part of the display surface of the display section 115.

By providing a power cut-off section 126 which is capable of selectively cutting off electric power in the portion relating to the function of the communicating section 114, it is possible to reliably stop the function of the communicating section 114.

As described above, according to the portable information device 110 of the present embodiment, since the piezoelectric vibrator 1 with high quality is provided, it is also possible to achieve a portable information device with high quality. Further, it is possible to display time information with high accuracy which is stabilized over a long time.

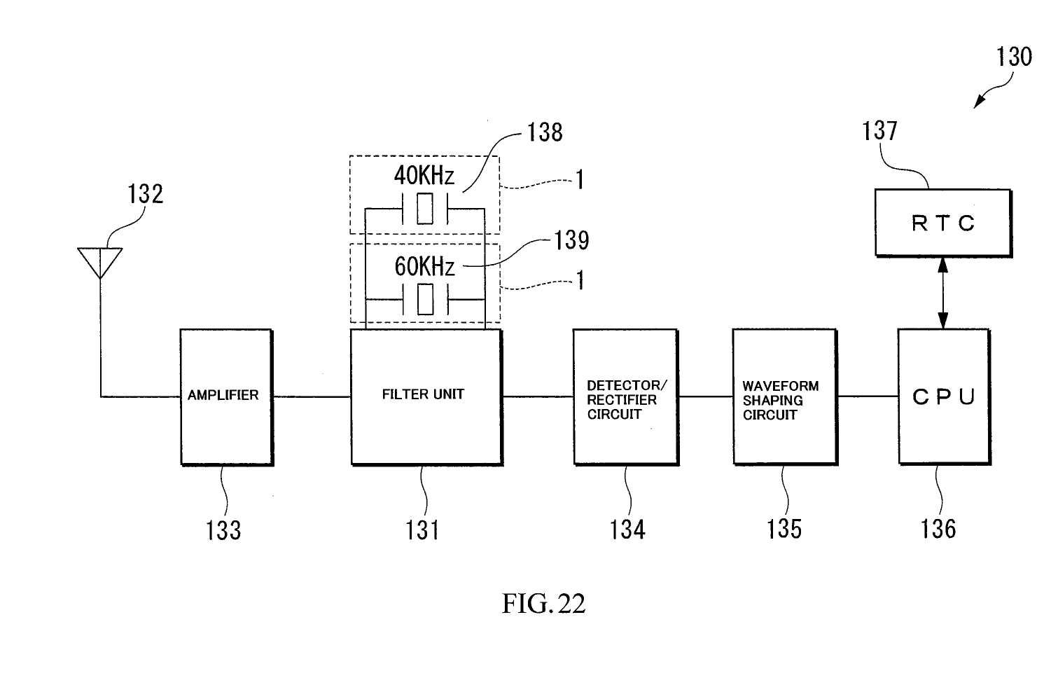

Next, a radio-controlled time piece according to an embodiment of the invention will be described with reference to FIG. 22.

A radio-controlled time piece 130 according to the present embodiment includes the piezoelectric vibrator 1 which is electrically connected to a filter section 131, as shown in FIG. 22, which is a time piece including a function of receiving a standard radio wave which includes time information and automatically modifying the standard radio wave at a correct time for display.

In Japan, transmitting stations (transmitter station) which transmit standard radio waves are present in Fukushima-ken (40 kHz) and Saga-ken (60 kHz), which transmit the standard radio waves, respectively. Since a long wave such as 40 kHz or 60 kHz has a characteristic of propagating on the ground surface and a characteristic of propagating while being reflected between the ionosphere and the ground surface, the propagation range is wide, and thus, the above-mentioned two transmitting stations cover the entire Japanese domestic area.

### (Radio-Controlled Time Piece)

Hereinafter, a functional configuration of the radio-controlled time piece 130 will be described in detail.

The antenna 132 receives the standard radio wave of a long wave of 40 kHz or 60 kHz. The long standard radio wave is obtained by AM-modulating time information called a time code into a carrier of 40 kHz or 60 kHz. The received long standard radio wave is amplified by an amplifier 133, and is filtered and syntonized by the filter section 131 having a plurality of piezoelectric vibrators 1.

Each piezoelectric vibrator 1 of the present embodiment includes quartz crystal vibrator sections 138 and 139 having a resonant frequency of 40 kHz and 60 kHz which are the same as the above-mentioned carrier frequency.

Further, the filtered signal of a predetermined frequency is wave-detected and demodulated by a wave-detection and rectifying circuit 134. Subsequently, a time code is read through a waveform shaping circuit 135 and is counted by a CPU 136. The CPU 136 reads information about the current year, integration date, day, time and the like. The read information is reflected in an RTC 137, and correct time information is displayed.

Since the carrier is 40 kHz or 60 kHz, a vibrator having the above-described tuning fork type structure is appropriately used as the quartz crystal vibrator sections 138 and 139.

The above description is an example applied in Japan, but the frequency of the long standard radio wave is different in other countries. For example, a standard radio wave of 77.5 kHz is used in Germany. Accordingly, in a case where the radio-controlled time piece 130 capable of being applied in other countries is assembled in a mobile device, it is necessary to provide a piezoelectric vibrator 1 of a frequency which is different from that in Japan.

As described above, according to the radio-controlled time piece 130 of the present embodiment, since the piezoelectric vibrator 1 with high quality is provided, it is possible to achieve a radio-controlled time piece with high quality. Further, it is possible to stably count time with high accuracy over a long time.

The technical scope of the invention is not limited to the above-described embodiment, and a variety of modifications may be made in a range without departing from the spirit of the invention.

For example, in the above-described embodiment, the trimming process (S94) is provided, but the process may not be provided.

Further, in the above-described embodiment, the dummy line forming process (S97) is performed after the second focus adjustment process (S96) to form the dummy line D on the front surface 50b of the wafer 50 for lid substrates, but if a detection target section including laser traces is formed on the front surface 50b, the dummy line D may not be formed. For example, a detection target section which is not a straight line may be formed, or a detection target section which is not parallel to the planned cutting line M but still has a straight line shape may be formed.

Further, in the above-described embodiment, the separator 83 is attached to the other surface 81c of the ring frame 81 so as to block the opening 81b (S101) before the breaking process (S103), but the invention is not limited to thereto. For example, an outer periphery of the separator 83 may be attached to a portion (portion where the opening 81b is blocked from one surface 81c) which is positioned on an inner side with reference to the ring frame 81 in the UV tape 80. Further, the separator 83 may not be provided.

Further, in the above-described embodiment, the scribe line M′ is formed on the front surface 50b of the wafer 50 for lid substrates in the breaking process and the cutting blade 70 is pressed from the rear surface 40b of the wafer 40 for base substrates, but the invention is not limited thereto. For example, the scribe line M′ may be formed on the rear surface 40b of the wafer 40 for base substrates and the cutting blade 70 may be pressed from the front surface 50b of the wafer 50 for lid substrates.

Further, in the above-described embodiment, the tear stress is applied to the wafer bonded body 60 using the cutting blade 70 in the breaking process (S103), but the tear stress may be applied by a different method.

Further, in the above-described embodiment, the expansion process (S113) is performed, but this process man not be performed.

Further, in the above-described embodiment, at the time of cutting the wafer bonded body 60, the magazine 82 is used, but this magazine may not be used.

Further, if the manufacturing method of the piezoelectric vibrator uses the cutting method of the bonded glass including the first focus adjustment process (S95), the second focus adjustment process (S96), the dummy line forming process (S97), the third focus adjustment process (S98), the scribing process (S99) and the cutting process (S100), but the invention is not limited to the above-described embodiment.

For example, the protection film forming process (S115) may not be provided.

Further, the piezoelectric vibrator 1 which is manufactured by this method may have a different structure from the tuning pork type piezoelectric vibrating piece 5 as the piezoelectric vibrating piece, and for example, may be a thick sliding piezoelectric vibrating piece, or the like. Further, the recess portion 3a may be formed in the base substrate 2, or may be formed in the substrates 2 and 3, respectively.

Further, in the above-described embodiment, the piezoelectric vibrator 1 in which the piezoelectric vibrating piece 5 is sealed in the cavity C is manufactured using the above-described cutting method of the bonded glass, but it is possible to manufacture a package in which an electronic component which is different from the piezoelectric vibrating piece can be sealed in the cavity.

Further, the above-described cutting method of the bonded glass may not be used as one process of package manufacturing, or may be individually applied when the bonded glass is cut.

Further, in the above-described embodiment, the wafer bonded body 60 in which two wafers 40 and 50 are bonded to each other through the bonding material 23 is cut using the above-described cutting method of the bonded glass, but it is also possible to apply the above-described cutting method of the bonded glass in cutting a bonded glass in which three or more glass substrates are bonded to each other through a bonding material.

Further, the components in the above-described embodiment may be appropriately replaced with known components and the above-described modified examples may be appropriately combined within a range without departing from the spirit of the invention.

What is claimed is:

1. A bonded glass cutting method for cutting, along a planned cutting line, a bonded glass in which bonding surfaces of a plurality of glass substrates are bonded to each other through a bonding material, the method comprising:
forming a detection target portion on a side surface of the bonded glass by irradiating the detection target portion with a laser light;
forming a groove on the side surface along the planned cutting line by irradiation of the laser light along the planned cutting line; and
cutting the bonded glass along the planned cutting line.

2. The method of claim 1, wherein forming the detection target portion comprises a forming a line, by the irradiation of the laser light, extending in parallel to the planned cutting line.

3. The method of claim 1, wherein the detection target portion is formed on the side surface outside of a package forming region that comprises a plurality of electronic packages embedded in the bonded glass.

4. The method of claim 1, further comprising, prior to forming the detection target portion, focusing the laser light on the bonding material by imaging the bonding material from the one surface side of the bonded glass.

5. The method of claim 4, further comprising, after the focusing, adjusting the focus of the laser light along the side surface of the bonded glass in a thickness direction of the bonded glass by a predetermined thickness.

6. The method of claim 4, further comprising, after forming the detection target region, adjusting the focus of the laser light to the planned cutting line.

7. The method of claim 1, wherein the groove is formed with a width of about 14 μm.

8. The method of claim 1, wherein the groove is formed with a depth of about 11 μm.

9. The method of claim 1, wherein cutting the bonded glass along the planned cutting line comprises applying a tear stress along the planned cutting line.

10. A bonded glass cutting method for cutting, along a planned cutting line, a bonded glass in which bonding surfaces of a plurality of glass substrates are bonded to each other through a bonding material, the method comprising:
focusing a laser light on the bonding material to irradiate the bonded glass from a side surface of the bonded glass by imaging the bonding material from the one surface side of the bonded glass;
after the focusing, adjusting the focus of the laser light along the side surface of the bonded glass in a thickness direction of the bonded glass by a predetermined thickness;
forming a detection target portion on the side surface of the bonded glass by irradiating the detection target portion with a laser light;
adjusting the focus of the laser light on the detection target portion by imaging the detection target portion from the side surface;
forming a groove on the side surface along the planned cutting line by irradiation of the laser light along the planned cutting line; and
cutting the bonded glass along the planned cutting line.

11. The method of claim 10, wherein cutting the bonded glass along the planned cutting line comprises applying a tear stress along the planned cutting line.

12. The method of claim 10, wherein forming the detection target portion comprises a forming a line, by the irradiation of the laser light, extending in parallel to the planned cutting line.

13. The method of claim 10, wherein the detection target portion is formed on the side surface outside of a package forming region that comprises a plurality of electronic packages embedded in the bonded glass.

14. The method of claim 10, wherein the groove is formed with a width of about 14 μm.

15. The method of claim 10, wherein the groove is formed with a depth of about 11 μm.

16. A bonded glass cutting method for cutting, along a planned cutting line, a bonded glass in which bonding surfaces of a plurality of glass substrates are bonded to each other through a bonding material, the method comprising:
a first focus adjustment process comprising focusing laser light;
a second focus adjustment process comprising moving the focus of the laser light toward one surface side of the bonded glass along a thickness direction of the bonded glass, after the first focus adjustment process;
a detection target portion forming process comprising forming a detection target portion on one surface by irradiation of the laser light, after the second focus adjustment process;
a third focus adjustment process comprising refocusing the laser light on the detection target portion;
a groove forming process comprising forming a groove on one surface by irradiation of the laser light along the planned cutting line, after the third focus adjustment process; and
a cutting process comprising cutting the bonded glass along the planned cutting line.

17. The method of claim 16, wherein forming the detection target portion comprises a forming a line, by the irradiation of the laser light, extending in parallel to the planned cutting line.

18. The method of claim 16, wherein the detection target portion is formed on the side surface outside of a package forming region that comprises a plurality of electronic packages embedded in the bonded glass.

19. The method of claim 16, where cutting the bonded glass along the planned cutting line comprises applying a tear stress along the planned cutting line.

20. The method of claim 16, wherein the groove is formed with a width of about 14 μm and a depth of about 11 μm.
